(19) United States
(12) Patent Application Publication
(10) Pub. No.: US 2015/0165690 A1
(43) Pub. Date: Jun. 18, 2015

(54) SYSTEMS AND METHODS FOR MANUFACTURING OF MULTI-PROPERTY ANATOMICALLY CUSTOMIZED DEVICES

(71) Applicant: Adam P. TOW, Boca Raton, FL (US)

(72) Inventor: Adam P. Tow, Boca Raton, FL (US)

(21) Appl. No.: 14/414,549

(22) PCT Filed: Jul. 17, 2013
(86) PCT No.: PCT/US2013/050792

§ 371 Date: Jan. 13, 2015

Related U.S. Application Data
(60) Provisional application No. 61/741,368, filed on Jul. 18, 2012.

(51) Int. Cl. B29C 67/00; G05B 15/02

(52) U.S. Cl. CPC B29C 67/0088; G05B 15/02

(57) ABSTRACT

Systems and methods for using a three dimensional fabrication device, like a 3D Printer, for novel automation and additive manufacturing techniques in manufacturing medical devices such as orthotics, customized for a particular person. The systems and methods may use a plurality of work surfaces on the three dimensional fabrication device. The systems and methods may use a plurality of materials or a plurality of fabrication tools and processes to manufacture the customized product.

### REFERENCE TO RELATED APPLICATIONS

This applicant claims the benefit of U.S. Provisional Application Ser. No. 61/741,368, filed Jul. 18, 2012 and incorporated by reference herein.

### BACKGROUND OF THE INVENTION

1. Field of the Invention

The present invention primarily relates to additive manufacturing systems and techniques, often referred to as three dimensional (“3D”) fabrication or 3D Printing.

2. Background

There have been many developments in additive manufacturing in recent years, and three dimensional fabrication or “printing” systems have become an increasingly practical means of manufacturing organic and inorganic materials from a digital model. Three dimensional fabricators are often referred to as additive manufacturing devices or 3D Printers. Such devices have also been adapted to work as part of, or in conjunction with, traditional computer numeric control (CNC) systems and other robotic motion or robotic arm systems, which have motions systems similar to those usable in additive manufacturing, but do not always include a deposition tool. A description of some exemplary 3D fabrication systems and recent developments in the art can be found in U.S. Pat. No. 7,625,198 to Lipson et al., and the patents and publications referenced therein. Commonly used 3D Printing technologies include Stereolithography (SLA), Fused Deposition Modeling and Free Form Fabrication, Ink jetting Processes, and Selective Laser Sintering (SLS).

The manufacturing and production of customized parts has traditionally been accomplished by manual labor, using both hand tools and larger scale machines to produce customized parts or prototype parts for small-scale production runs. Recent advances in 3D Printing technology have provided a new means of creating customized parts and prototypes; however, there is a limit to the type and quantity of products that can be produced with 3D Printers given their narrow materials set and the high cost of ownership and operation. More recently, reductions in the cost of three-axis robotics systems have provided new opportunities to utilize novel additive manufacturing techniques in low cost devices, and make them accessible to previously underserved or unserved users.

Particularly in the medical field, where custom medical products are not usually available on demand, there exists a need for a 3D Printing technology to manufacture custom medical devices that will provide physicians and others the ability to prescribe a custom medical device, create it immediately, and test its efficacy on patients in real time, rather than waiting weeks for custom manufacturers to complete manual processes. The term medical device as used herein is not limited to that which is prescribed by a physician or used to treat a particular ailment, but also extends to include any article which is created with respect to a biological feature, attribute, or requirement. For example, this could include orthotics/prosthetics, implantables, prescription, custom orthotic insoles, as well as specialized non-medical gear used in sporting, such as customized helmets and padding.

By way of example, orthotic is a term that can be used with regard to the design, manufacture and application of orthoses, also referred to generally as an orthotic or orthotics. (Prosthetics are closely related to orthotics and often function similarly.) Custom orthotic shoe insoles are also often referred to simply as orthotics. Generally, orthotics are externally applied devices used to modify the structural and functional characteristics of the neuromuscular and skeletal system, and are typically used to: (1) control, guide, limit and/or immobilize an extremity, joint or body segment for a particular reason; (2) restrict movement in a given direction; (3) assist movement generally; (4) reduce weight bearing forces for a particular purpose (5) aid rehabilitation from fractures after the removal of a cast; or (6) otherwise correct the shape and/or function of the body, to provide easier movement capability or reduce pain.

The current process for producing a custom orthotic is slow, expensive and subject to flawed results. For example, with respect to a custom insole, a clinician may take an impression of a patient's foot, using either a plaster cast or a foam impression (in rare instances, complicated hand-held 3D Scanners are used to digitally perform the same function). The impressions are then sent to an offsite orthotics lab which produces the orthotic by hand using the impression and a basic prescription as a guide. The process usually involves hand casting, vacuum forming, or milling from a solid piece, and subsequent manual assembly of several components, such as padding. The process will often take two weeks or more. The clinician must then test the orthotic on the patient to ensure it functions properly, and accurately reflects the prescription. It is difficult and often impractical to make further modifications to the costly orthotic that would enhance efficacy or comfort for the patient. In some instances, the patient (or some other non-professional) may take the place of a clinician and alternative means of capturing the patient impression (such as foot pressure mapping) may be used. Likewise, pre-fabricated orthotics may be “matched” to patients by some means, such as using pressure map data, to achieve approximately custom results.

Traditionally-manufactured orthotics are necessarily limited by the technologies used to create them. The main corrective part of the orthotic, its shell, is typically a rigid piece made from a single solid/uniform material, although padding can be added by subsequent manual assembly. Because traditional manufacturing works by sculpting or forming the shell from a uniform bulk material, it typically exhibits no internal variation in geometry or mechanical properties, only a simple external geometric shape with a clinically and usually functionally arbitrary interior substructure. In other words, the entirety of the shell is made from a material that is fashioned in a particular shape, and limited to the intrinsic characteristics of the material from which it is made. The same is true of any additional components, such as padding or posting, which are cut from uniform materials. Notably, these components are manufactured by a different process on a different machine from the shell, and often both fabricated and assembled by hand.

Some do manufacture the shell component of the orthotic with computer-aided design and manufacturing (“CAD/CAM”) techniques, particularly CNC milling machines, which supplement the remaining, subsequent manual aspects of the process. These “subtractive manufacturing” milling techniques produce orthotics inherently limited to the characteristics of the solid blocks of typically uniform material from which they carve a shell. While additive manufacturing could be used to fabricate an orthotic shell, the current state-of-the-art technology has not been adopted by orthotics labs, as milling is, by most criteria, a superior technique for this application. Fabricating an orthotic shell using currently available 3D printers relying on conventional printing techniques that are, by default, limited to mono-material prints using a uniform (non-functional) fill pattern, would yield a shell of equal or lesser quality to a milled one. A fill pattern can refer to, among other meanings, the ‘internal geometry’ created within a 3D Printed structure by the “filling in” (printing) of the area inside the outer margins of a 2D layer slice. Indeed, the current methods of 3D printing a “closed” geometry (as would generally be used for an orthotic) provide limited benefits over milling from a solid block, since printing a single, uniform fill pattern is functionally equivalent (or inferior) to milling a solid block of uniform material. Indeed, a 3D Printed object is typically more costly, time intensive, and less durable than a milled one, due to the laminated structure imposed on objects made with many 3D printing techniques. Thus, the use of 3D printing technology in the medical device field has generally been limited to complex external shape matching, with little to no perceived advantage over pre-existing manufacturing techniques for most common applications.

Traditional orthotic manufacturing requires that a user selects a base shell material in advance, limiting the user to that material's intrinsic mechanical properties for the orthotic's principal structural component. While the addition of exterior padding or the removal of material (i.e., drilling) could be used to further modify the orthotic, this requires additional manual processing steps and separate components must be (manually) glued together, reducing product quality. Traditional manufacturing generally limits orthotic design to a single (usually hard) material cast of, e.g., a foot, which may then be supported by various padding (on the dorsal aspect of the orthotic) and angled into a “biomechanically neutral” position by the addition of postings (glued on platforms on the plantar aspect of the orthotic). The dorsal aspect of an orthotic is described herein as the surface, which comes into contact with the plantar aspect of the foot. These constraints necessitate a multi-step manufacturing process with manual inputs at various points in the process. Manufacturing orthotics with common milling techniques also limits the creation of the main structure (e.g., foot mold) to a solid, uniform material—a derivative of the solid block of material used as a starting point in the milling process. Even if an injection molding processes was used (prohibitive cost notwithstanding), the results would still be uniform or at least standardized.

Generally, orthotics manufacturing, particularly with respect to insoles, is limited to manual or partially manual processes. These processes limit the features and quality of the orthotics which can be created for patients. Achieving beneficial variation in mechanical properties in an orthotic is difficult, and often impractical, if not impossible. Attempting to fabricate orthotics which exhibit various mechanical properties to correspond to practical or clinical needs requires the manual labor-intensive combination of many custom components. It would be desirable to have a means to fabricate multi-property orthotics with little or no manual labor to increase usability, clinical efficacy, the feasible feature set, and decrease cost and lead time. Current technologies cannot fabricate an entire orthotic without manual assembly steps, nor can they effectively create a shell with properties different from those intrinsic to the inputted bulk material, necessarily requiring that a top coat (padding and other components) be glued onto a shell. These limitations are inherent in the current orthotics fabrication process, regardless of how the shell is fabricated.

Unlike what is taught with respect to the present invention, existing 3D Printing systems do not specify variations in fill pattern, material, etc. in a manner that addresses clinical considerations or practical patient needs. As such, using existing 3D Printer technology would only support fabrication of the orthotic's shell—the piece typically milled from a solid block. The 3D Printed shell would be created using a single rigid material (e.g., Acrylonitrile butadiene styrene (“ABS”)/Polylactic acid (“PLA”)) with a fill pattern dictated by a non-clinical concern, such as reducing print time or saving material; typically a by-product of a 3D Printer's default material deposition pathing algorithm, which is created without any consideration for clinically or functionally relevant patterning. Such a fabricated shell, like its milled counterpart, would require manual processing to add layers of padding to accommodate the printed shell, and would not generally confer many benefits over traditional orthotic manufacturing techniques. Producing orthotics “in-office” represents a largely unmet need as current technologies such as noisy, debris-generating milling machines (and were they to be used, traditional 3D Printers) produce a raw product—a simple shell—unacceptable to clinicians, who have not adopted milling machines for in-office use in large number due to the requirement to adding a second top coat material (and possibly additional padding) which necessarily involves significant manual labor and skill. Moreover, an in-office medical device production system would need to perform a variety of tasks, such as scanning anatomies and fabricating multiple orthotics in a reasonable work flow.

It would be desirable, however, to have manufacturing devices and methods that could combine one or more materials and arrange them in various shapes and internal patterns such that a custom medical device could be created with less manual input and digitally and precisely exhibit varied properties, as dictated by the biomechanical or practical needs of the patient. This would allow the creation of more effective orthotics and likely help increase patient compliance by adding precision and flexibility to the orthotics which could be easily created for patients.

### SUMMARY OF THE INVENTION

The shortcomings of the prior art can be overcome and additional advantages can be provided with the additive manufacturing systems and techniques described herein. The present invention can thereby make additive manufacturing more practical and may result in a drastic improvement in output product quality. Some of the features provided by the system of the present disclosure are described as follows:

A three dimensional fabricator, having a control unit for receiving instructions from a fabrication command unit and operating one or more tool heads, and a plurality of work surfaces upon which the at least one tool head can fabricate a product. Additionally, the instructions can specify that the tool head fabricate a product customized for use by a particular person. Additionally, the fabricator can be configured to run a first process using a first work surface that can be interrupted, and a second process can be initiated to use a second work surface, and then the first process using the first work surface can be resumed. Additionally, the fabricator can be configured to use a first work surface for an additive manufacturing process and use a second work surface for a laser scanning process. Additionally, the fabricator can be configured such that a first process using a first work surface blocks access to materials located on a second work surface.

A three dimensional fabricator, having a control unit for receiving instructions from a fabrication command unit and operating at least one tool head, a work surface for fabrication of a product with the (at least one) tool head, and with instructions specifying the combination of at least two materials to manufacture a product customized for use by a particular person. Additionally, the instructions can be based or customized in part on a person's anatomy or biomechanical properties. The instructions can also be based or customized in part on the mechanical properties of a separate article or device which can be interfaced with the manufactured product. Additionally, the instructions can specify: (1) a particular ratio or arrangement in three dimensional space of the combination of the at least two materials in one or more regions of the product; (2) a particular pattern to be manufactured in one or more regions of the product; (3) different printing processes for at least two regions of the product; (4) different internal geometries for at least two regions of the product; (5) at least one functional pattern on an external region of the product; and/or (6) specify at least one functional geometry on an external region of the product. The product can be a medical device, an insole, and/or footwear.

A method of using a three dimensional fabricator to manufacture a product, including the steps of: sending instructions for a product with mechanical properties customized for a particular person from a fabrication command unit to a control unit; operating at least one tool head with the control unit to fabricate a product on a work surface; and fabricating the product with the customized mechanical properties on the work surface. Additionally, the mechanical properties can address a medical need of the particular person. The product can be a medical device, an insole, and/or footwear. Additionally, fabricating the product may further comprise the combining of at least two materials, and those two materials may optionally be combined with a specific ratio to achieve one or more of the selected mechanical properties. Additionally, fabricating the product further comprises: (1) the use of at least two additive manufacturing tools; (2) the fabrication of at least one internal geometry or pattern; (3) different regions of the product with at least two different patterns; (4) different regions of the product with at least two different printing processes; (5) at least one functional pattern on an external region of the product; and/or (6) at least one functional geometry on an external region of the product.

A three dimensional fabricator, having a control unit for receiving instructions from a fabrication command unit and operating at least one additive manufacturing tool head and at least one subtractive manufacturing tool head, a work surface for fabrication of a product with the (at least one) additive manufacturing tool head and the (at least one) subtractive manufacturing tool head, and with instructions specifying the fabrication of material on the work surface to manufacture a product customized for use by a particular person. Additionally, the product can be a medical device or an insole.

A three dimensional fabricator, having a control unit for receiving instructions from a fabrication command unit and operating at least one tool head, a work surface for fabrication of a product with the (at least one) tool head, and with instructions specifying the combination of at least two materials on the work surface to manufacture a medical device. Additionally, the medical device can be an insole.

A method of using a three dimensional fabricator to manufacture a medical device, including the steps of: sending instructions from a fabrication command unit to a control unit; operating at least one tool head with the control unit to combine at least two materials; and manufacturing a medical device with the at least one tool head on a work surface. Additionally, the medical device can be an insole.

The present invention has many embodiments, some of which are described herein, and others which should be apparent to the reader or can be inferred from what is taught herein.

### BRIEF DESCRIPTION OF THE DRAWINGS

FIG. 1 is a perspective view of an exemplary prior art three dimensional fabricator.

FIG. 2 provides an exemplary prior art process for a three dimensional fabricator.

FIG. 3 illustrates the construction of an exemplary prior art orthotic insole.

FIG. 4 illustrates some common types of orthotic padding and modifications that can be used in custom orthotic insoles.

FIG. 5 provides an orthotic production workflow in accordance with an embodiment of the present invention.

FIG. 6 illustrates an orthotic having regions of varying properties, as can be manufactured an embodiment of the present invention.

FIG. 7 provides a different perspective of an orthotic having regions of varying properties, as can be manufactured by an embodiment of the present invention.

FIG. 8 provides a more detailed orthotic production workflow in accordance with an embodiment of the present invention.

FIG. 9 provides an exemplary laser scanning and data acquisition process that may be used in accordance with an embodiment of the present invention.

FIG. 10A provides one perspective for an exemplary laser scanning procedure that may be used in accordance with an embodiment of the present invention.

FIG. 10B provides a second perspective, corresponding to FIG. 10A, for an exemplary laser scanning procedure that may be used in accordance with an embodiment of the present invention.

FIG. 11 illustrates different possible slopes detected between points acquired by a laser scanning technique for generating a digital representation of a patient's anatomy.

FIG. 12A illustrates one aspect of a software application interface that may be used in accordance with an embodiment of the present invention.

FIG. 12B illustrates a second aspect of a software application interface that may be used in accordance with an embodiment of the present invention.

FIG. 12C illustrates a third aspect of a software application interface that may be used in accordance with an embodiment of the present invention.

FIG. 13 illustrates an exemplary multi-tool 3D printer tool head that can be used in conjunction with an embodiment of the present invention.

FIG. 14 illustrates an exemplary 3D printer that can be configured as an embodiment of the present invention and can use different printer tool heads.

FIG. 15 illustrates an embodiment of the present invention having a specialized build surface, such as a spheroid depression, for use with a 3D printer.

FIG. 16 illustrates an embodiment of the present invention having a specialized build surface, such as a textured surface, for use with a 3D printer.

FIG. 17 illustrates an embodiment of the present invention having a specialized build surface, such as one designed to create an orthotic with less material by supporting the arch, for use with a 3D printer.

FIG. 18 illustrates an embodiment of the present invention having a 3D printer with a secondary work surface can be engaged and can block a primary work surface.

FIG. 19 illustrates a top-down perspective of an embodiment of the present invention having engaged an additional work surface.

FIG. 20 illustrates a top-down perspective of an embodiment of the present invention having engaged an additional work surface, with a tool head cutout.

FIG. 21 illustrates a top-down perspective of an embodiment of the present invention having engaged an additional work surface, with a tool head cutout and tool head.

FIG. 22 illustrates an embodiment of the present invention having a 3D printer with a secondary work surface engaged by moving the primary work surface.

FIG. 23 illustrates an embodiment of the present invention where one or more additional removable work surfaces can slide into position for use by the 3D printer.

### DETAILED DESCRIPTION OF THE PREFERRED EMBODIMENT(S)

### 1. Benefits and Features of Embodiments of the Present Invention

Before detailing particular embodiments of the present invention, it may be helpful to further describe various limitations of the prior art and the corresponding features in embodiments of the present invention that can overcome those limitations.

Unlike the prior art, and as described further herein, embodiments of the present invention can support the creation of a fully functional custom medical device with regions of varied mechanical properties, without multiple manual assembly steps. Certain existing methodologies do exist for altering mechanical properties in 3D-printed objects by using combinations of two materials in a grid-based ink jetting processes or by using material combinations in extrusion deposition processes. Additionally, mechanical variation in 3D-printed products has been accomplished in single-material objects by using air voids via a handful of unique patterning methods. However, these techniques have not been adopted for use in custom medical devices such as orthotics, nor have any such techniques been further developed to reflect clinical concerns, clinical data, or practical considerations particular to custom medical devices such as orthotics. Further, these technologies, while all labeled 3D Printing, are not currently available in integrated devices.

For example, 3D Printers can generate functional fill patterns, such as described in U.S. Pub. No. 2012/0241993 entitled “SYSTEMS AND METHODS FOR FREEFORM FABRICATION OF FOAMED STRUCTURES” and published on Sep. 27, 2012 (filed as U.S. application Ser. No. 13/356,194 on Jan. 23, 2012); however, these techniques have not previously been used to print custom medical devices such as orthotics in accordance with pertinent clinical data. Several techniques for printing functional patterns have been created for general purpose printing, but until now, no method or system for implementing functional material deposition patterns or material combinations in view of clinical data has been introduced. Moreover, no device or comprehensive system exists to automate the entire process of manufacturing custom medical devices such as orthotics using additive manufacturing (3D Printing) technology.

3D Printing has in certain instances been used to create unique external geometries based on patient-specific geometries. For example, printers have been used to create parts which conform to the external shape of a patient's anatomy. But only embodiments of the present invention utilize 3D Printing technology to create functional mechanical variations in custom medical devices such as orthotics based on clinical requirements or practical patient needs. This enables a physician or clinician to benefit from unique attributes of 3D Printing technology to manufacture custom medical devices such as orthotics with a desired external geometry (shape), as well control the processes by which that shape is generated, such that it has regions of varying mechanical properties based on clinical considerations or practical patient needs.

By using clinical data and varying the material properties in a 3D printer's output, one can manufacture custom medical devices such as orthotics having unique properties that are customized for the intended user (i.e., patient). It is also possible to manufacture functionally-novel device geometries because alteration of both geometry and material compression properties can be used to replace the need for traditional posting and padding of manufactured devices. For example, in cases where bunion joint pain would necessitate manual removal of a portion of an orthotic to alleviate pain (pressure), embodiments of the invention would allow one to simply alter the fill pattern or materials at certain areas (or implement another 3D Printing process variation, such as the level heating or other changes possible even within a single material). Of course, printing the necessary hole is also possible. In addition, in accordance with embodiments of the invention, padding and structural support (e.g., an orthotic shell) can be modified across a controlled, continuous spectrum to achieve patient specific results, as opposed to the discrete combinations possible when using mass produced padding to supplement a rigid orthotic device manufactured in the traditional manner. This is now possible because the effective change in Young's Modulus (i.e., compression or stiffness), traditionally achieved by manually combining a particular shell material and pads, can instead be achieved by 3D printing a single structure (of one or more materials) that utilizes available processes, patterns, materials, or combinations thereof to achieve the desired mechanical properties. The embodiments introduce use of the combination of one or more materials in one or more processes and/or in one or more patterns to fabricate medical devices using additive manufacturing. Some limited mechanical property modification might be provided using external geometric features (such as an orthotic with externally printed springs) and a 3D Printed topcoat of a different material, thereby incorporating a multi-material feature into such embodiments of the invention. Mechanical properties can refer to Young's Modulus, Sheer Modulus, Coefficient of Friction, and a host of other properties. As used herein, the term “mechanical properties” can extend beyond its traditional meaning to encompass any property that can be manipulated by the printing process/technology or materials, including, among others, properties traditionally classified as material, bulk material, porosity, optical, thermal, or electrical properties.

Embodiments of the invention can also provide a single integrated system for the entire process, from initial input of the orthotic geometry through final manufacturing of custom medical devices such as an orthotic. Embodiments of the invention also offer the ability to vary and combine functional patterns and/or processes to respond to clinical demands, as well as practical needs such as producing an orthotic that accurately grips a shoe or foot. This unification of the prescription process and the creation of a custom medical device enables a physician to directly customize and control the medical device production (i.e., the 3D Printing process including deposition, materials, fill patterns, etc.) in order to more accurately and efficiently address a clinical diagnosis and need. By using an embodiment of the present invention, a physician could select a particular mechanical property (which could be presented as choices among familiar materials whose properties would be mimicked or by selection from any other scale) and the 3D Printer could manufacture a custom medical device reflecting the desired mechanical property in a particular selected region by configuring the printing processes as necessary. This process of creating an orthotic to correspond to a clinical or practical need (e.g., shoe shape or usage) could be automated using inputted data and decision algorithms.

Embodiments of the present invention also introduce a system and method for using a single material or single manufacturing process (e.g., 3D Printing) to manufacture all the components of custom medical device—such as the shell, posting, padding, gripping, etc. of an orthotic product—and where all such components could be customized by direct manipulation of the printing process. For example, even if one could print the complete external shape of an orthotic using existing techniques for a 3D Printer, the medical device resulting from that uniform production process would not function correctly because it would not contain different components or regions having distinct mechanical properties. But as noted above, embodiments of the present invention enable a user to customize and alter various aspects of the printing process, such as the fill pattern and materials, in order to accommodate mechanical variations in the different functional aspects of the medical device, as customized for use by a particular patient. Embodiments of the present invention offer additional features benefiting the patient, but not related to the medical purpose of the device (i.e., in embodiments having a classically defined medical purpose). For example, with respect to a foot orthotic, it would be advantageous to impregnate materials with antimicrobial or odor fighting properties at specific areas in the orthotic. Similarly, it would be advantageous to create orthotics which can fold along the long axis and spring back to fit into a difficult shoe geometry.

While the methodology and exemplary embodiments for altering the 3D Printing process to create custom medical devices with varying regions of functional internal structure or material combination in response to clinical concerns is primarily discussed herein with respect to orthotic insoles, the same techniques can be applied with respect to other products created to interact with the human body, including a wide array of medical devices, prosthetics, orthotics, and non-clinical devices customized to anatomy. As such, while the exemplary embodiments relate primarily to the customized manufacturing of orthotic insoles, one skilled in the art will appreciate how the present invention applies to other medical devices and products. Likewise, the exemplary embodiments presented herein focus primarily on additive manufacturing systems such as 3D Printers, and in particular on solid free form fabrication using deposition tool heads, but it should be understood and appreciated that the present invention can be implemented in a wider variety of embodiments and robotic devices.

Given the limitations of the current systems and the inconvenience they impose on clinicians, it is desirable to have a system of more efficiently producing superior customized medical devices such as orthotics and other fabricated articles. This is especially the case where it is preferably to have a single device capable of performing many tasks, such as laser scanning and fabricating orthotics.

Currently, additive manufacturing devices are generally limited to producing one object at a time, or producing a series of objects simultaneously on a single work surface. For example, a 3D Printer being used to fabricate toys would be limited to fabricating only as many toys as could fit within the confines of its single work surface. In most cases, the fabrication of the toys would need to be simultaneous (i.e., each layer from two distinct objects would need to be deposited in succession), whereby layer one of object one would be followed by layer one of object two, and layer two of object one, and layer two of object two, and so on. If this was not the case, and two objects were being fabricated on one work surface sequentially (or with any substantial lag), a larger work surface would be required so that the tool fabricating the second object would not make contact with the first object (at a later or completed stage of fabrication) while printing. However, a user of an additive manufacturing system may wish to fabricate multiple items of varying geometry within a short period of time. For example, the current approach of using a single work surface would not allow someone who is fabricating one object of reasonable size to easily fabricate a second object of shorter print time (e.g., smaller size) while the first object is fabricated. Previously, there was no effective means of “interrupting” a fabrication process to perform another task. In the context of an additive manufacturing system, this second task may be the fabrication of a second item, as described above. However, it is also possible that the interrupting task may be a non-printing task.

As will be discussed herein, embodiments of the present invention may be used for both 3D Printing and laser scanning, such as first laser scanning an impression of a foot and then fabricating a corresponding orthotic. In the past, a hypothetical machine with such dual capability would generally not be able to pause the fabrication of an object being printed in order to laser scan a second object (e.g., a second impression). Reasons for this incapability could be the inability to fit both objects on a single work surface, and the risk that introducing a second object for scanning to the work surface might result in damage to the first object being fabricated. This is just one of many illustrative scenarios in which embodiments of the present invention would be desirable.

Generally, as single- and multi-function robotically controlled motion systems (such as 3D Printers) become more commonplace, particularly in home and office scenarios, it is likely that users will wish to switch among various tasks and tools. It is therefore desirable that a multi-function machine, or more generally a machine used to perform multiple tasks, be able to separate various functions and/or tasks onto different work surfaces, which would provide many benefits such as hygiene, quality, efficiency, and space saving.

Due to the inherent complexities of additive manufacturing, CNC, and similar systems and the shortcomings in currently known techniques, existing systems may fail to provide users with a means to efficiently multi-task. Current products limited to single work surfaces do not make them amenable to the performance of multiple tasks of varying duration on objects of varying geometry. In particular, it is desirable to have robotic systems and techniques that allow a user to deploy multiple work surfaces, wherein several tasks and tools can be used sequentially or simultaneously. This is especially true in the fabrication of orthotics, particularly in an in-office setting, where a compact machine capable of multi-tasking between printing and scanning jobs would have clear benefits in terms of cost, training, office space, and efficiency.

### 2. Description of Prior Art Systems and Methods

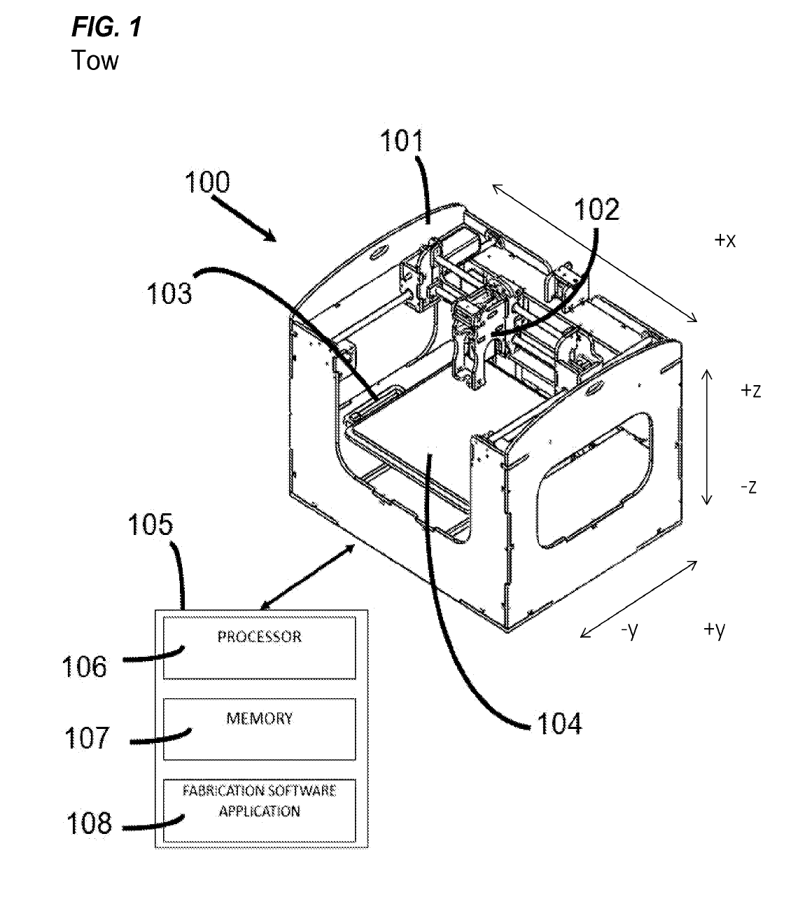

In order to provide some background regarding three dimensional robotic motion systems in general and illustrate common components in such devices that may be used in connection with embodiments of the present invention, FIG. 1 provides a perspective view of a prior art three dimensional fabricating system. It should be understood that embodiments of the present invention are not limited to a three dimensional fabricating system as shown in FIG. 1 and could be implemented by properly adapting other systems with robotic arms or computer-controlled motion, which may or may not resemble the system shown in FIG. 1. In FIG. 1, fabrication system 100 includes fabricator 101 with material deposition tool head 102 (also referred to herein as deposition tool or deposition head), control unit 103 having one or more actuators and sensors configured to control operating characteristics of material deposition tool 102, and build tray (i.e., build surface, work surface, or fabrication surface) 104. Fabrication command unit 105 may be coupled to fabricator 101 as a component physically inside fabricator 101, or it may be coupled as an external device (e.g., computer) via a wired or wireless connection.

Notably, in some other robotic systems which could be used to implement embodiments of the invention, material deposition tool 102 might be replaced with another type of tool, or a combination of tools, or an interchangeable tool (deposition or otherwise). Embodiments of the invention could also be implemented with machines not specifically known or used as “fabrication” systems, such as “scanning” systems (like those using a laser scanner) or by other robotic machines.

With respect to FIG. 1, fabrication command unit 105 includes processor 106, memory 107, and fabrication software application 108 that can be stored in memory 107 and executed by processor 106. It should be appreciated that control unit 103 of fabricator 101 may be configured to receive instructions from fabrication command unit 105 such that fabricator 101 can fabricate an output product on build surface 104 from materials dispensed by material deposition tool 102.

The fabricated output product can be a three dimensional structure comprising a plurality of deposition layers. Material deposition tool 102 typically deposits material in viscous form and the material can be designed to solidify after being deposited to form an output product on build surface 104. Alternatively the material may require a separate curing process to solidify it, or may remain in a viscous form capable of maintaining a three dimensional structure. Output products are generally three dimensional structures created by a plurality of deposition layers. Fabrication software application 108 can generate tool path information for fabricator 101 and delineate how material can be used to generate shapes with entrapped air. Complex CAD programs may also be used to generate the intended geometry.

Embodiments of the present invention may be implemented in any suitable three-dimensional fabricating system (i.e., additive manufacturing device or 3D Printer), for example, as illustrated in FIG. 1 and described above, or in a combination of systems. Some other exemplary three-dimensional fabricating systems or components thereof are described in U.S. Pub. No. 2012/0241993 entitled “SYSTEMS AND METHODS FOR FREEFORM FABRICATION OF FOAMED STRUCTURES” and published on Sep. 27, 2012 (filed as U.S. application Ser. No. 13/356,194 on Jan. 23, 2012) and U.S. Pat. No. 7,625,198 to Lipson et al.

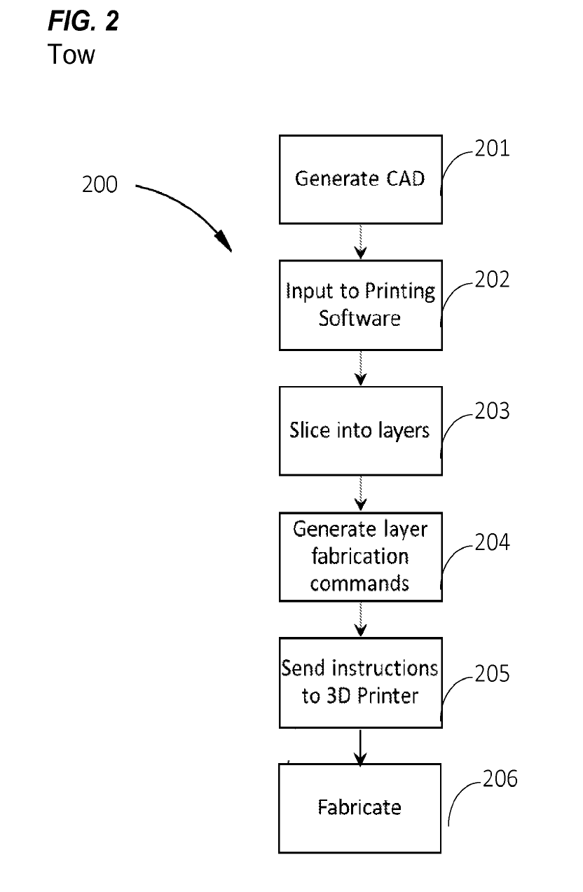

FIG. 2 provides exemplary process 200 for 3D Printing. Computer aided design (CAD) data generated by a user and/or software 201 can be provided as input to 3D printing software 202 which typically “slices” the CAD data into multiple (z-axis) layers 203 and generates fabrication directions or commands for each layer 204 which are transmitted to the fabrication components in a 3D Printer 205 to fabricate an object 206. Depending on the particular 3D printing technology employed, the layer fabrication commands may consist of x-y motion (typically tool head ‘pathing’) instructions and deposition/sintering/light curing instructions. Also, depending on the particular 3D Printer being used, it is possible that the pathing motion in the x-y-z axis may be achieved by motion of either a tool head and/or a build surface. One of ordinary skill in the art will recognize that there are many possible variations and configurations of the 3D printer (FIGS. 1) and 3D printing procedure (FIG. 2) described herein that may be used in systems for additive manufacturing, but the above description should provide sufficient background of available systems that can be used in connection with embodiments of the invention.

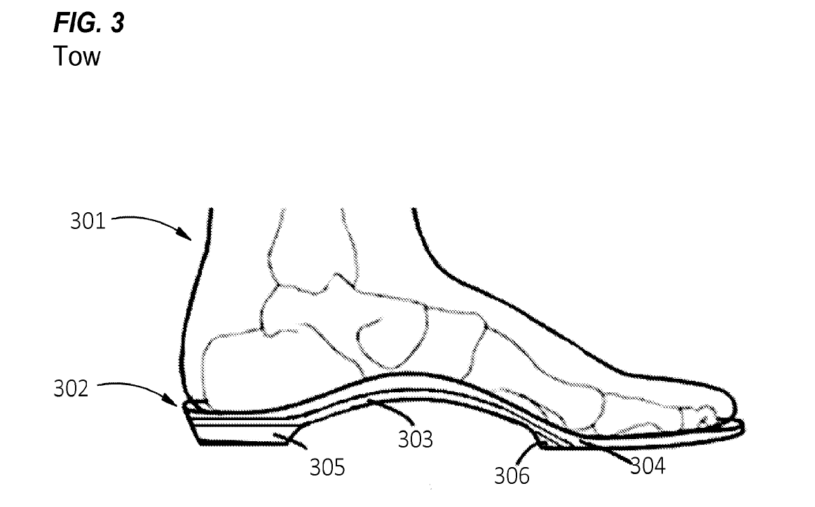

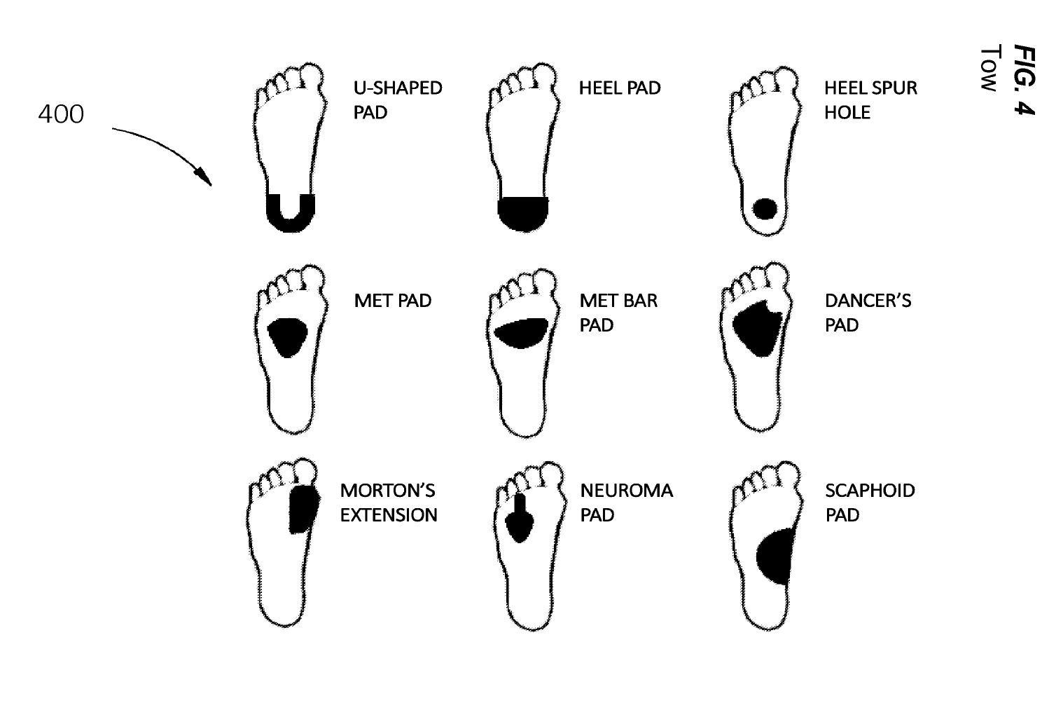

FIG. 3 provides an introductory understanding of orthotic construction. Foot 301 is shown atop traditional custom orthotic insole 302. Insole 302 is shown as having a shell 303 which is typically made of a rigid material (e.g., plastic) that is milled or vacuum formed to correspond to the impression taken by the clinician. Several accommodative pads or shell modifications (e.g., drilled holes) of the type shown in FIG. 4 may be used to alter the shell. The shell is typically then affixed to a top coat 304, which may extend past the length of the shell 303, at which point is it often referred to as a forefoot extension. Such top coats or coverings exhibit various degrees of padding. Clinical concerns including the adjustment of the plane in which the foot is positioned may call for angled rearfoot posting 305 and/or forefoot posting 306.

FIG. 4 provides illustrations of exemplary pads or holes 400 which may be prescribed by a clinician to address common clinical conditions using well known orthotic prescriptions. Traditionally, these pads (or holes) 400 would be placed on top of (or through) a milled or handcrafted orthotic shell molded to fit a patient's foot, sometimes reducing contact with the fitted shape and foot and increasing the ability for the patient to slide off the orthotic. Moreover, the variety of pads 400 are typically mass produced, limiting the mechanical properties which a clinician can offer a patient to the specific predetermined offerings of pad manufacturers. If a patient desired a custom pad, it would be expensive, time-consuming, and require a great deal of manual labor. Further, the manual nature of traditional orthotic construction does not provide a digital model for quantitatively assessing the mechanical property effects of padding and shell construction, as is possible using the present invention.

### 3. Description of the Preferred Embodiments

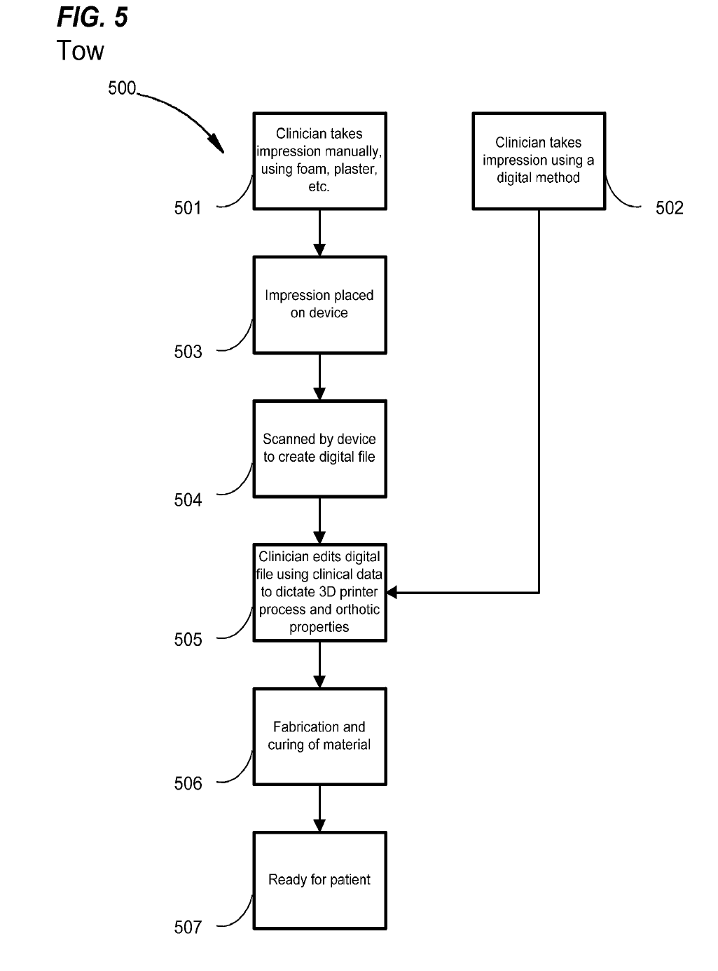

FIG. 5 provides workflow overview 500 to illustrate one possible embodiment of the present invention. In this embodiment of the invention, a clinician can capture the physical characteristics of a patient's anatomy (e.g., a mold) through a variety of means, including but not limited to foam or plaster 501. (Actions by a clinician as described herein could alternatively be taken by a physician, the patient, or some other user, or several users together.) A clinician can then scan the mold or impression with an orthotics manufacturing device or an imaging device (e.g., digital scanner or camera) 503 to create a digitized record of the patient's anatomy 504. Alternatively, the clinician can use another method such as imaging device (e.g., digital scanner or camera) to create a digitized record of the physical characteristics of a patient's anatomy without using a mold 502. The clinician may then process the digital record with specialized software 505. Software 505 can be configured to enable a clinician to design a custom medical device, such as an orthotic, in view of the digital record of the patient's anatomy. For example, with respect to a foot orthotic, the clinician may be able to specify a particular pad or shell and optionally modify the shape of the pad or shell, add a forefoot extension, change mechanical properties in different elements of the orthotic material, etc. in view of the clinical and practical needs of the patient. Specialized software 505 can be integrated into the orthotics manufacturing device, or may be available on a separate computer. Specialized software 505 may optionally be able to analyze the digital record of the patient's anatomy and recommend particular customizations to the clinician. In addition, specialized software 505 may optionally have access to one or more clinical or medical data repositories that it can reference to recommend particular customizations to the clinician. Specialized software 505 may also allow the clinician to directly access one or more clinical or medical data repositories to research potential customizations. Specialized software 505 can generate a three dimensional model or other instructions or data for a customized medical device, which can be transmitted directly (wired or wirelessly) or indirectly (e.g., via a USB flash drive) to a fabrication device which manufactures the custom medical device and allows for any needed curing of materials 506. The custom medical device, such as an orthotic, is then complete and can be provided to the patient 507.

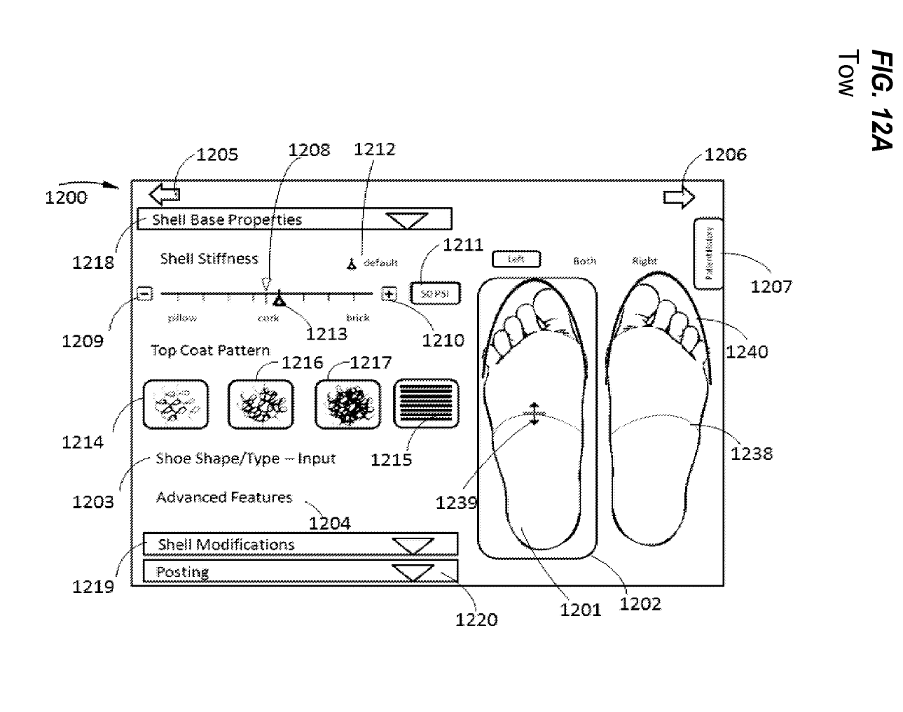

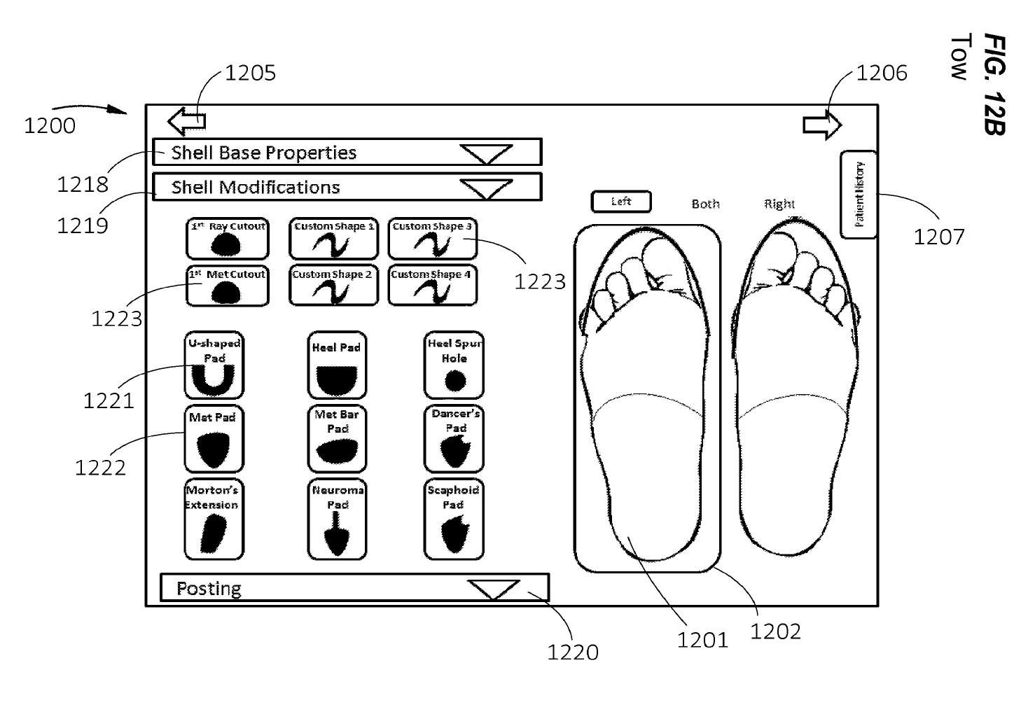

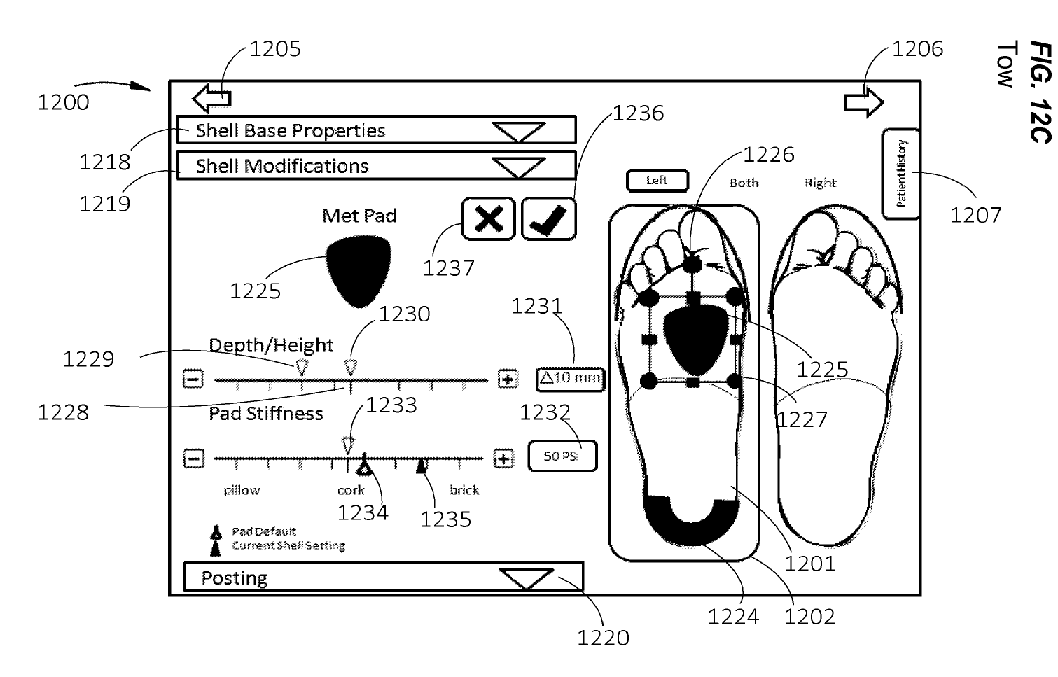

As discussed above with respect to FIG. 5, embodiments of the invention may utilize specialized software to process digital (or digitized) records about the geometry of a patient's anatomy to render a custom medical device (e.g., an orthotic). The clinician can also use specialized software to further customize features of the medical device. For example, starting with an anatomy-based shell for a foot orthotic generated in response to the digitized record, a clinician can direct the specialized software to add a u-shaped pad. However, whereas a u-shaped heel pad would traditionally be a distinct component placed on top of an orthotic shell, the clinician could direct the specialized software to integrate the pad into the structure of the shell of the orthotic itself. The specialized software may also offer a clinician the option of raising the pad from the surface of the orthotic shell. (This is illustrated below in reference to FIGS. 12A-C.) The specialized software may also enable a clinician to change the mechanical properties for particular regions of the custom medical device. For example, the mechanical properties of a u-shaped region in a foot orthotic could be manipulated to be more compressive or less compressive under a patient's weight, relative to other regions of the foot orthotic.

Assignment of mechanical properties to various aspects of the medical device may be done by computer software using data such as the anatomical data, physical exam data, pressure data, CAT scan or MRI data, and data about the properties of any interfacing hardware like a patient's shoe. Different embodiments of the invention used may have varying degrees of clinician discretionary intervention, with some embodiments completely automating the process of assigning mechanical properties to the medical device based on the digital data available.

In this embodiment, the clinician would first determine if the u-shaped region should be raised (and/or recessed) from the foot's mold, and if yes, to what degree. Then the clinician could select the degree of resistance to compression of that region, as compared to other regions on the orthotic. These variations of compression properties (as well as other mechanical properties) could be created by manipulating the additive manufacturing process, for example, by altering the composition of different fabricating materials being used, and altering the deposition process. Another example where modifying mechanical properties might be beneficial could be trying to alter the orthotic's expected response to sheering forces, in order to accommodate a patient's gait or athletic needs.

In a simple example, a hard piece of the orthotic (with respect to Young's Modulus) and a soft piece—e.g., the shell and the pad, respectively—could be fabricated by one (or more) 3D printer(s) as a single physical object by utilizing two different printing processes, where one process produces the portion of the object that is hard like plastics or resins, and a second process produces the portion that is softer and more akin to silicones or thermoplastic elastomers. A wide array of materials, in conjunction with a wide array of processes, could be used to create a variety of mechanical properties in different regions (and at various ratios) within a custom medical device, in order to accommodate clinical and practical needs. Even with respect to a single material, additive manufacturing processing algorithms can be used to change the mechanical properties of that material in different regions of a custom medical device, such as an orthotic.

For example, when employing extrusion-based 3D printing, the properties of a single material can be altered by introducing variations in the pattern of the deposition path of an extrusion head as it layers material on a work surface. Other techniques could also be employed, such as using overlapping loop-depositing paths (rather than straight lines) by varying both the tool head path and its deposition settings, as can be induced by phenomena such as viscous thread instability. (Aspects of this technique are described in U.S. patent application Ser. No. 13/356,194, referenced above.) These techniques enable the deposition of coiled paths of varying coil shape, size, and lateral and vertical overlap, creating various desired mechanical properties by a combination of several factors including density and number of node connections between loops. Techniques using non-looped strands or strands of varying shapes, thicknesses, and patterns can also be used. Other techniques could include linear stacking patterns where the fill is not solid—this can result in creating pockets of air in the custom medical device, or creating paths for air to pass through the custom medical device. These variations can be induced by several methods, including but not limited to: (1) altering a CAD file to introduce external or internal substructures (e.g., “springs”), (2) modifying height, speed, material calibration or other tool head settings, or (3) manipulating the pathing-patterning algorithm used to create motion and deposition instructions from the CAD layer slices. Another useful technique for creating custom mechanical properties is using coiled or other functional fill patterns that alone would introduce air voids, but depositing one or more other materials to fill in what would otherwise be air voids. This could be done by depositing the air-replacing material during or after the printing of the coiled pattern. Similarly, honeycomb or similar grid-like patterns can be created with one or more materials using a variety of well-known additive manufacturing technologies.

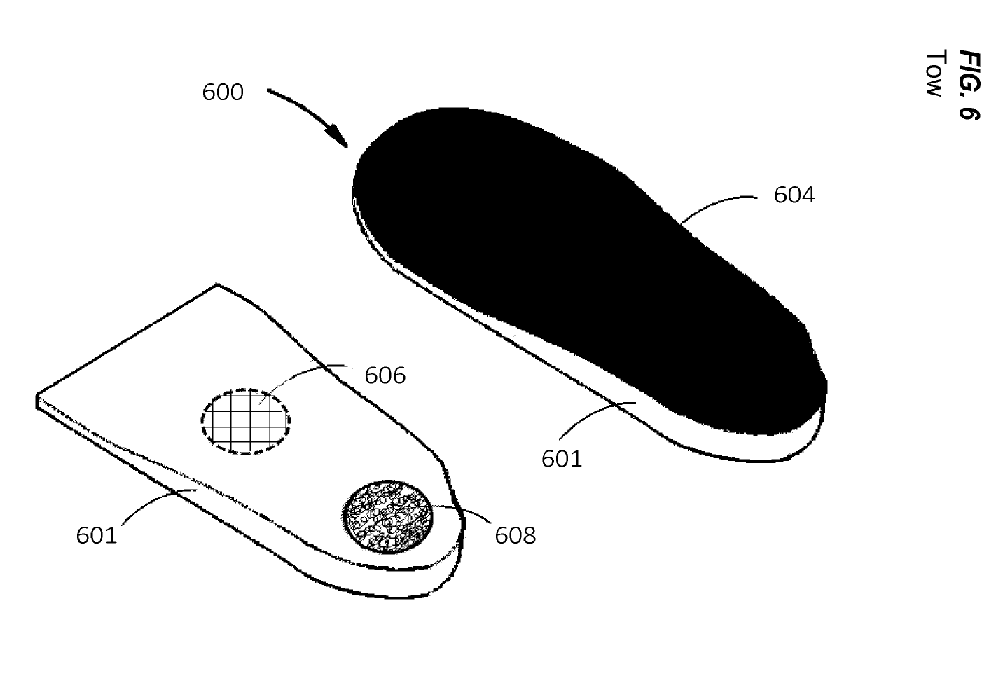

FIG. 6 provides an illustrative custom medical device, in this instance foot orthotic 600, which could be manufactured by embodiments of the present invention as described herein. Orthotic 600 has a shell 601 that is fabricated by an extrusion process, optionally with an internal crisscross-style grid pattern 606 or another structural design (such as a honeycomb structure) in certain regions of orthotic 600, with said regions optionally being fabricated using hard plastic or soft (i.e., more compressive) materials like certain TPEs or silicones. Such patterns are beneficial when customizing a medical device to be lightweight, and used selectively, they can provide desired mechanical properties while minimizing the quantity of material used, as well as minimizing fabrication time. (With respect to FIG. 6, it should be understood that the dashed lines around crisscross pattern 606 represent an internal view of the pattern which may be fully enclosed within shell 601 or beneath the top coat 604.) Products similar to orthotic 600 could also be manufactured with ink jetting, sintering, or comparable fabrication processes using a variety of materials. In addition to the hard (i.e., stiff) portion of orthotic shell 601, orthotic 600 may also comprise compressive padding material 608 in certain regions. A looped deposition pattern of a soft material such as silicone or thermoplastic elastomer can be deposited to form padding material 608 with a precise Young's Modulus that differs from the other regions of shell 601. A third material, or the same soft material as padding material 608—perhaps with a tighter pattern—may be deposited to form top coat 604. (As illustration of “tight” versus a “loose” pattern is provided can be visualized in the contrast between patterns 1215 and 1214 in FIG. 12A below.) In some embodiments, multiple materials may refer to multiple colors of a single material which could be used to delineate among regions representative of traditional components, e.g. shell and top coat. In the present example, orthotic shell 601 could be created with a patterned surface to allow mechanical interlock of a second (or third) material for top coat 604, should one be desired, or as a means to grip the foot. It is also possible for shell 601 and top coat 604 to be created with depositions at different resolutions, such that shell 601 could be created with a courser resolution at a quicker speed, while it can be coated with a finer resolution top coat 604, giving orthotic 600 an outward appearance and feel of a high resolution print.

Embodiments of the present invention are not limited to specific patterns, specific materials, or specific combinations of such patterns and materials. Rather, embodiments of the present invention can use these various patterns, materials and 3D fabrication techniques to manufacture custom medical devices such as orthotics with unique mechanical properties and attributes. Indeed, some embodiments of the invention can utilize non-printing techniques in conjunction with printing techniques. For example, using a one or more fabrication devices, a clinician could mill an orthotic shell and deposit a top coat (and pads) using an additive manufacturing process.

Looped patterns such as those illustrated with respect to padding material 608 and similar structures could be fabricated in a custom medical device such that they allow fluid to pass through, allow oxygen to travel through to the body part adjoining the medical device, prevent odor or buildup, and/or allow internal portions of the device to be washed and dried.

A custom medical device may have particular regions in which several layers of one or more materials are deposited in one or more patterns to accommodate particular needs of a patient. For example, a patient may have a foot orthotic created where the dorsal aspect of the orthotic is fabricated in a loose pattern to allow air to permeate that region and act as a cushion for the foot, whereas the plantar aspect can be fabricated with a more solid pattern in order to maximize the surface area in contact with the patient's shoe, so as to maximize the orthotic's grip and help the patient walk better or more comfortably. There may also be regions within an orthotic that differ from the predominant properties of the orthotic to provide a softer feel (or some other attribute) in order to accommodate a localized issue, such as pain in a calcaneus or bunion joint. Mechanical properties can be designed to provide a cost effective orthotic which performs clinical functions and address practical concerns (e.g., fitting, gripping, bending, etc.).

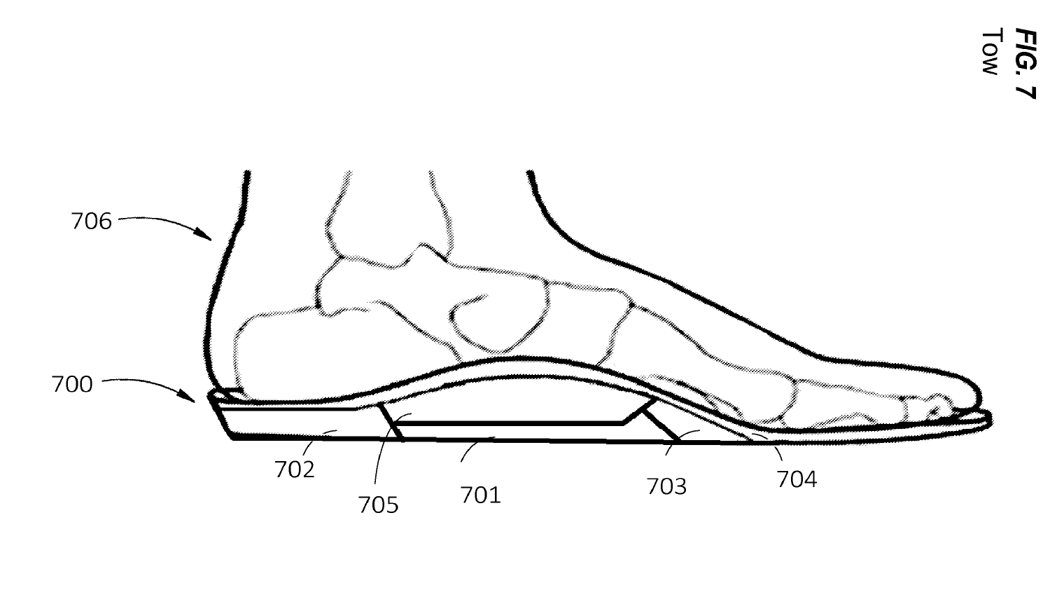

FIG. 7 illustrates an orthotic having a flat bottom that can be fabricated with an embodiment of the invention, in this example, integrating the often assembled postings 305 and 306 as shown in FIG. 3 directly into the shell geometry. Embodiments of the invention thus allow for a multi-component orthotic 700 to be manufactured as a single object, and in some instances a single object from a single material of various properties. Embodiments of the invention allow for the external geometry (shape) of a custom medical device as well as the internal geometry to be modified, and specialized software as described herein can assist a clinician in modifying external and/or internal geometries to fabricate a custom medical device based on clinical data and practical considerations in order to achieve desirable qualities and attributes. The specialized software may assist the clinician in designing a custom medical device in view of dimensional constraints (e.g., shoe dimensions), available materials, particular processes supported by the clinician's 3D Printer, and the mechanical properties desired for various regions of the medical device. This flexibility enables a clinician to fabricate a customized medical device with desired attributes despite possible limitations in available supplies and tools, in view of practical realities of the patient's anatomy, or other common limitations (e.g., shoe size).

Different printing processes can be used in accordance with embodiment of the invention to construct orthotic 700 in FIG. 7 with a variety of mechanical properties. Regions such as those exemplified by 701, 702, 703, 704 and 705 can be comprised of different materials or material compositions, comprise different deposition patterns, or reflect different fabrication processes, in order to provide those respective regions of orthotic 700 (and the overall orthotic, by consequence) with distinct weight, texture, compression (Young's Modulus) or other attributes. By allowing for integration of a posting into the flat bottom orthotic 700 as a single object, embodiments of the invention can extend the posting across the entire orthotic and fill the area between rear and forefoot posting with material. When embodiments of the invention are implemented in this manner, the printed region beneath the foot's arch allows for more effective use of functional patterning because with more area to print, the effects of fill pattern changes on Young's Modulus (and other mechanical properties) can be more pronounced and felt by the patient's foot 706. Such orthotics could also be fabricated without the need for a dissolvable or removable support material. To be clear, embodiments of the invention may also create foot orthotics with a gap between the rear and forefoot posting and arch. Further, a “loose” patterned or easily compressed region below the arch (approximately represented at 701 and 705) can also be printed to avoid use of support material, while still creating an orthotic that can fit into shoe styles traditionally more amenable to the orthotic style shown in FIG. 3. It is also possible to create orthotic 700 such that it can be folded along its length, by creating a gap between the material which forms the portion of the orthotic below a top coat component in region 704, or by otherwise using flexible materials appropriately. Many other such designs which accommodate practical patient needs, such as shoe constraints, can be easily produced with an embodiment of the invention. Other examples include creating orthotics which are compliant along one axis or direction and rigid along the other. An exemplary technique by which this could be accomplished is by varying a deposition pattern longitudinally. Such orthotics could be rolled up along their length and folded into a shoe, springing back to a functional position when released into the shoe. They could also be used to provide flexibility in certain regions and provide rigidity in others for clinical reasons. Similarly, embodiment of the invention can be used to fabricate orthotics which wrap around heel or other portions of the foot for increased contact and correction, as well orthotics which snap into prefabricated devices such as, helmets, shoes, or pre-fabricated medical braces, such as an insole snapping into an ankle-foot orthotic (AFO) or similar prefabricated device.

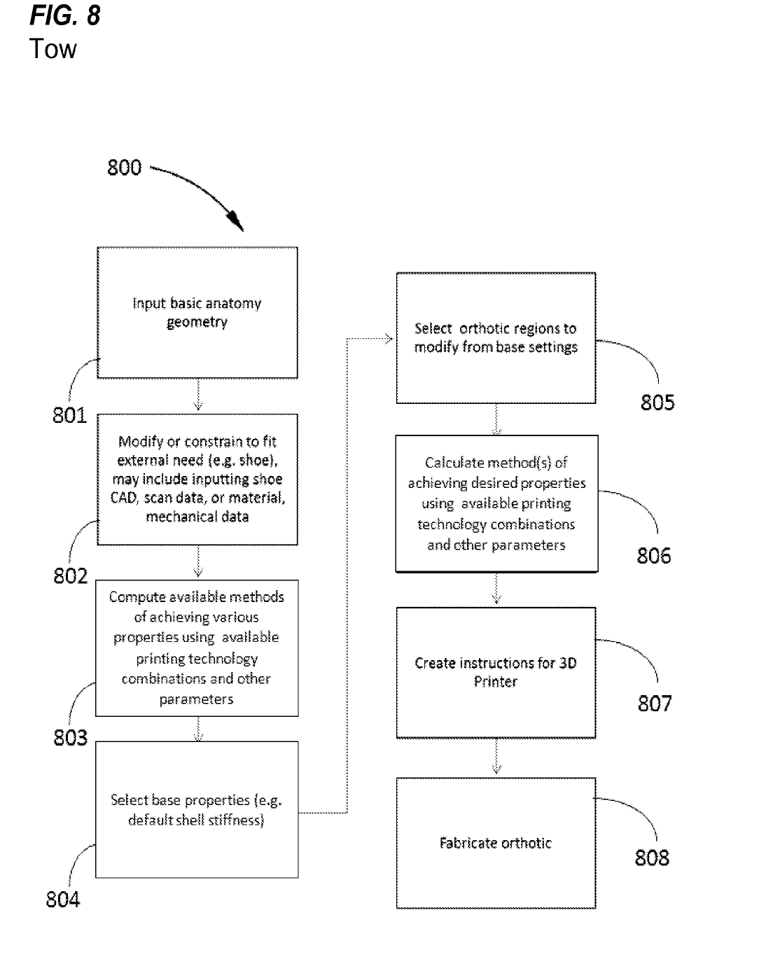

FIG. 8 provides workflow 800 for an embodiment of the invention. After inputting basic anatomy geometry in Step 801 (such as via transmission of digitized records), a clinician can modify the geometry to meet any desired constraints in Step 802. For example, the clinician can modify the geometry in view of a particular shoe type or a specific shoe, which may be obtained and processed in a variety of methods, including laser scanning of the shoe's existing insole or receiving shoe (or other interfacing device) information regarding geometry or mechanical properties stored on an external database, etc. Other information constraining the overall geometry may also be input at this step. (Note that the steps can be practiced out of order in many instances, and automation, variation, combination, elimination, or addition of steps is possible within different embodiments of the invention.) In this embodiment, with a basic external geometry defined in Step 802, the various assignable properties can be computed in Step 803 based on the available technology (e.g., by processing information about various processes, materials, and fill patterns supported by the clinician's 3D Printer in order to calculate default or recommended procedures for the 3D Printer to fabricate those properties). By way of example, a simple printer limited to two materials in a single pattern could perform Step 803 to calculate available Young's Moduli by calculating the possible composite Young's Modulus range resultant from combining said materials in various possible positions and ratios. The basic shell geometry created from the patient's anatomy is then defined with base material properties 804, from among those available, particularly the stiffness (i.e., Young's Modulus) desired. Step 804, in particular, can be delayed or combined with subsequent steps (e.g., Step 805), depending on the particular embodiment of the invention. Specialized software such as a Fabrication Software Application can be used in embodiments of the invention to present the clinician with a graphical user interface (“GUI”) which simplifies the customization of the intended medical device; other embodiments may automate all or most of the process. For example, various settings and features can be displayed for the clinician with default settings, known reference points, sliding scales, graphic images, etc. In step 805 the clinician can modify the settings and properties of various regions of a desired medical device. In step 806, the software analyzes the clinician's input and processes required adjustments to its tentative procedures for the 3D Printer (e.g., from data in Step 804). This may be performed by using established engineering and computer modeling techniques for calculating mechanical properties of a digital model of known structure and materials. The process may also be conducted with less sophisticated modeling techniques, by simpler calculations arising from the combination of a known, limited set of materials and deposition patterns with known properties. It is also possible for embodiments of the invention to have software configured to make a single calculation in step 806 to generate procedures for the 3D Printer (i.e., skipping step 804). Yet other embodiments of the invention may operate in other manners that achieve the same end result (i.e., instructions for the 3D Printer). For example, embodiments may have software configured iteratively—reactively rejecting clinician adjustments that exceed constraints of the 3D Printer, or proactively—by preventing the clinician from making adjustments that are not supported by the 3D Printer, or by preventing the clinician from making unreasonable adjustments. After calculating procedures to manufacture the desired external geometry with textures, materials, processes, and fill patterns (for the internal structure), the software may generate a final set of instructions in step 807 that can be transmitted to the 3D Printer (directly or indirectly), and the custom medical device can be fabricated in step 808. As noted above, these steps reflect one of many possible embodiments of the invention, as they can be practiced in modified orders, steps can be combined or replaced with other similar-functioning steps, and workflow 800 can be shortened with preprogrammed shortcuts, such as with the availability of default settings that can be used by a clinician (e.g., for different orthotic regions, for different clinical diagnoses, etc.).

With reference back to step 801, embodiments of the invention may use a laser scanner or other digital imaging device to create a digital representation of a mold (e.g., foam box or plaster casting) of a patient's anatomy. Other embodiments of the invention could include, but are not limited to, digital imaging equipment integrated directly into a manufacturing device such as a 3D Printer. For example, such a device could include a depressible pin matrix that records the height of different points on the mold in order to generate a digital map of the corresponding anatomy. Embodiments of the invention may also utilize other patient data in conjunction with the mold/impression/cast, and it should be understood that embodiments of the invention are not limited to use of a physical mold and other embodiments, such as those using a digital scan of a patient's actual anatomy, could be used in conjunction with the features discussed herein. For example, a mold may be laser scanned, and then pressure map data or gait analysis data can be collected using, e.g., digital pressure mapping techniques. It would then be possible, for example, to customize the medical device in view of pressure data. Modifications to particular regions of clinical concern could then more precisely match pressure profiles of a patient.

Another example of using other patient data would be information regarding the shoe worn by the patient, wherein a map of the shoe's various features, geometry, and mechanical property profile can be digitally scanned, received from available data sources, or manually input by the clinician in order to customize a foot orthotic which takes into account the aggregate properties of the total interface between patient and external contact surface, i.e., the surface on which the patient walks. Yet another example would be scanning a shoe to further analyze defects in a patient's walk or gait, such as by detecting which portions of a shoe's sole are prematurely or non-uniformly worn out. Further, the use of pressure mapping can accomplish similar customization results to increase comfort or aid in treatment of conditions like diabetic ulcers, where pressure could be redistributed appropriately for healing. Such principles could be applied to other custom medical devices, generally. For example, embodiments of the invention could be used for a custom designed sports helmet, wherein the geometry and mechanical profile of a prefabricated portion of the helmet could be integrated into patient-specific custom padding designs created for that helmet. As with insole orthotics, embodiments of the invention could be directed to the creation and customization of a shoe (or helmet) with insole (or padding) integrated directly, by fabricating the entire shoe (helmet) or building directly on top of an existing prefabricated starting point. The same techniques could be applied to a wide variety of prosthetics, such as customizing the padding of a prefabricated prosthetic leg to accommodate a patient's stump. Likewise, embodiments of the invention could be used to fabricate a customized implant (e.g., a cervical disc implant constructed using MRI data), or an external brace to remedy back ailments, a neck brace, or a cast or splint for, e.g., an arm or leg. Other examples include implantable plates, specialized grips for golf clubs, or carpal tunnel braces, etc. Embodiments could also be used to create a series of orthotics for a patient, such as a juvenile patient, requiring progressive correction over time.

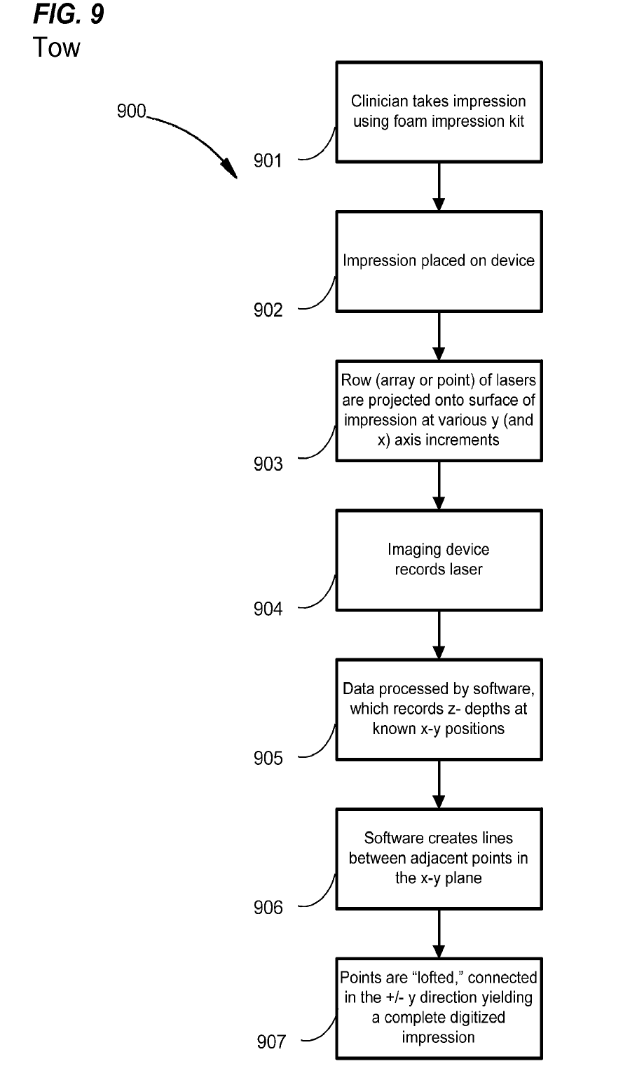

Laser scanning process 900 is shown in FIG. 9 in accordance with an embodiment of the invention. Laser scanning process 900 is a means by which a digital representation of a patient's anatomy or a mold of a patient's anatomy can be generated. A clinician can optionally use a standard podiatric kit to create a mold of patient's anatomy in step 901. A plaster slipper cast may be used, for example, as an alternative to the foam mold impression. The mold (or the patient's actual anatomy) can be placed on or in an imaging device in step 902. The imaging device can be a standalone unit or can be part of the 3D Printer. In certain embodiments of the invention where the device is part of the 3D Printer, the mold or patient's anatomy could be placed on the same work surface used for 3D fabrication. In other embodiments, the imaging device may be available on a different work surface, and in some instances an ongoing fabrication process on one work surface may be able to proceed while the imaging device is used simultaneously on a different work surface. In some embodiments of the invention, one or more work surfaces may accessible by a single integrated tool head comprising both fabrication capabilities (e.g., printing and/or other CNC tools) as well as digital imaging (i.e., scanning) capabilities. Alternatively, the fabrication and imaging components can be interchangeably, or separately attached to a 3D Printer. Embodiments of the invention may also be designed as several devices working in parallel, or several devices working in serial fashion and optionally have robotic means of moving components or products between devices, such as with a conveyor belt.

There are a number of acceptable ways to generate digital information corresponding to the physical mold (or the patient's actual anatomy) in order to manufacture a custom medical device in accordance with embodiments of the invention. In the particular implementation described in FIG. 9, a point, row, or array of lasers can be projected onto the mold (or the patient's actual anatomy) in step 903 so a digital scanner or camera can capture the laser projections along the mold (or the patient's actual anatomy) in step 904. The captured information is processed by software in step 905 which can identify the position of the laser on the images and, for example, use simple trigonometric calculations to create a series of z-heights at known x-y positions. In step 906 the software connects adjacent points in x-y the plane and takes the x-y spline (e.g., a curvy line) connected in the previous step 906 and connects it in the y-direction, “lofting” it into a digitized impression in step 907. The resulting data may then undergo some additional post-processing (not shown), which may include a border defining algorithm (which could utilize slope change thresholds or an inputted shoe geometry), as well as feature detection algorithms, such as to identify the heel cup border which may show a zero derivative at the heel's most posterior position if analyzed as a spline created in a roughly parabolic shape about the heel region. Other anatomical features can be detected (perhaps via anatomical heuristics) to allow alignment of the basic orthotic shape derived from a potentially crooked impression into a perfectly straight position most ideally suited for orthotic fabrication. Such feature detection or (manual) assignment may be useful in default pad positioning, as well. Manual adjustment of the scan alignment in all three directions is possible, as well.

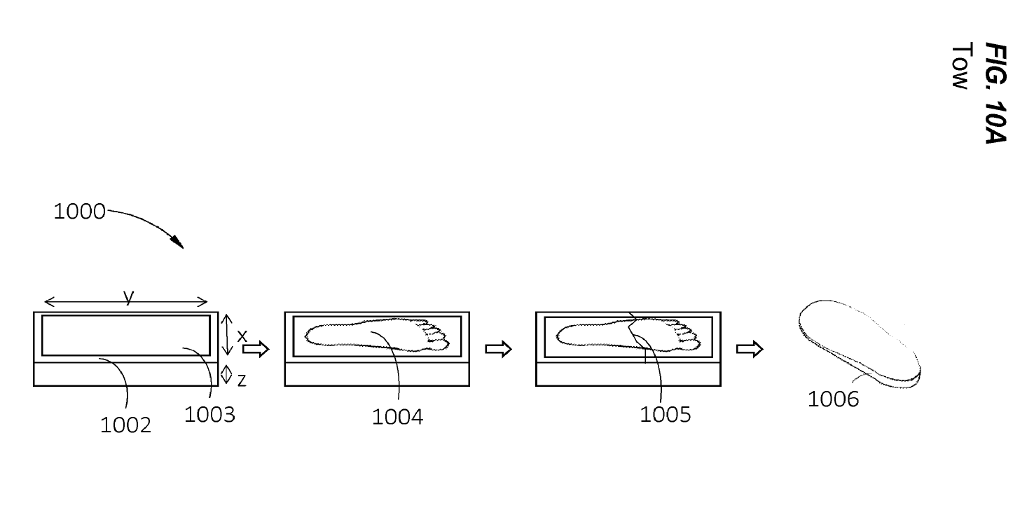

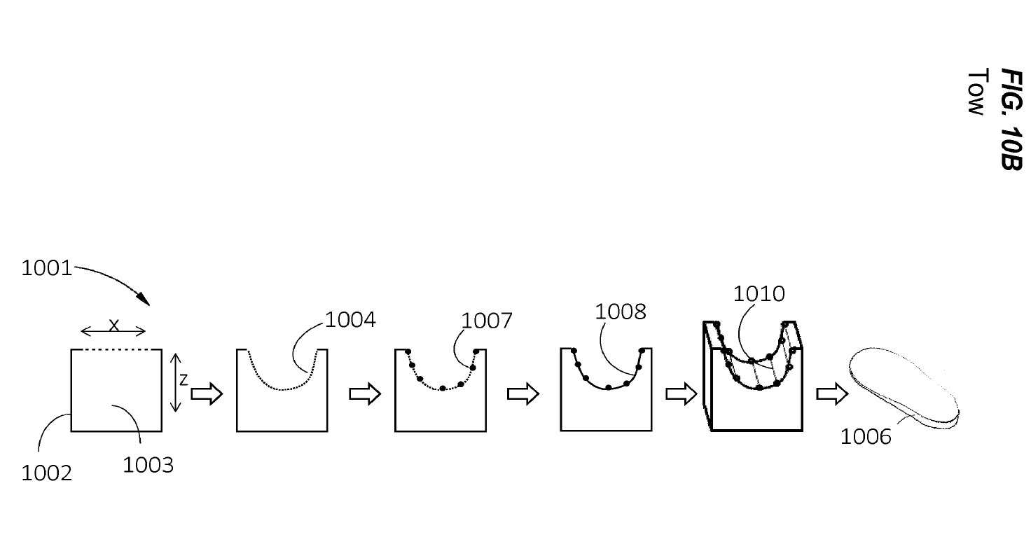

Some embodiments of the invention may utilize a variety of laser scanning technologies to capture anatomical data. For example, a laser scanner which uses a camera (or color capture device) to capture an image of a laser point, line or array projected onto an anatomy impression can use simple trigonometric calculations to calculate z-heights at various points in x-y space with respect to the impression. Accordingly, FIGS. 10A and 10B provide two perspective views of an exemplary process to generate digital information corresponding to the physical mold of a patient's anatomy in order to manufacture a custom medical device in accordance with embodiments of the invention. In perspective view 1000 of FIG. 10A, box 1002 may contain depressible foam 1003 which can be imprinted with a patient's foot as shown in imprinted foam 1004. The impression in imprinted foam 1004 can then be scanned using a laser line 1005 along the x and y axis, to yield a z-axis height map of the impression at various x-y positions to generate digital representation 1006. Illustrated in FIG. 10B is x-z cross section perspective 1001 corresponding to perspective 1000, wherein box 1002 can contain depressible foam 1003 which can be imprinted with a patient's foot as shown in imprinted foam 1004. In one configuration, the laser scanning process can detect a series of discrete points in the impression, such as point 1007, and record its z-height and corresponding x-y position. Detected points in the impression, such as point 1007, can then be used to compute lines, such as line 1008, which approximate the continuous nature of the impression such that all x-z axis points in a particular plane can be connected into an x-z axis spline. Each x-z axis spline can also be connected (“lofted”) to the splines in the y axis direction, for example, y-axis line 1010. The same technique can be practiced in several directions using alternate coordinate system designations. This process (which may involve further processing using known geometric computation techniques) can provide a complete digital representation 1006.

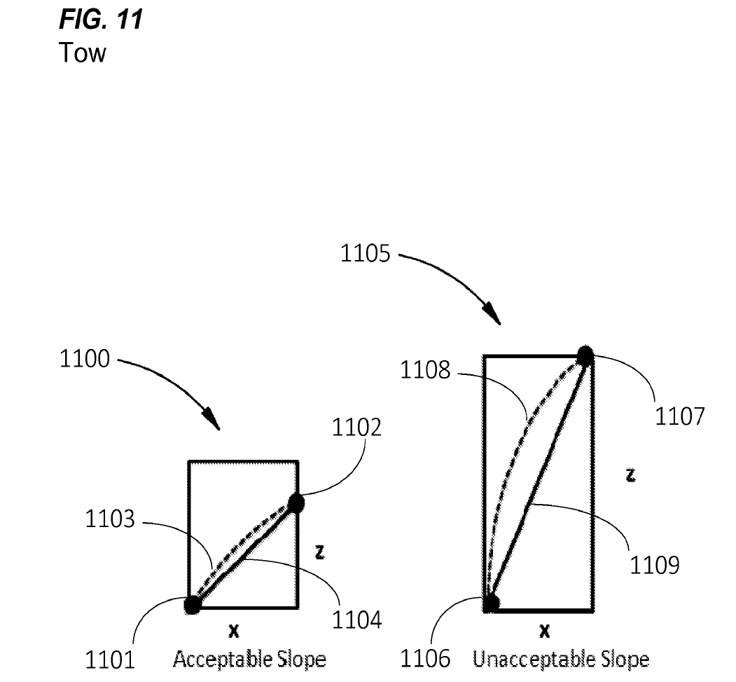

As shown in FIG. 11, methods of optimizing scan resolutions and timing may be employed in embodiments of the invention. Algorithms may be used to perform a fast, low resolution scan followed by a more detailed, slower scan at various points, optionally changing scanner direction, as well. For example, a more detailed scan may be useful at points where steep slope changes are detected as they could indicate a loss of feature resolution. In box 1100 of FIG. 11, discrete points 1101 and 1102 on the x-z axis can be recorded with a laser scanning process to approximate the continuous nature of the impression by generating line 1104 to represent the slope of the actual physical impression shown as dashed line 1103. Likewise, discrete points 1105 and 1106 on the x-z axis in right-hand box 1005 generate line 1109 to represent the slope of the actual physical impression shown as dashed line 1108. In FIG. 11, line 1104 in box 1100 is shown as more accurately capturing the geometry of the actual physical impression—indicated by the relative closeness of line 1104 to dashed line 1103. By contrast, line 1109 is further from the actual physical impression shown as dashed line 1108. Thus, when significant slope changes are detected, as in box 1105, supplemental scans (e.g., at intermediate, unscanned points or performed at higher resolution) could record additional discrete points within the same region in order to generate more precise lines, such that the ultimate x-z spline created in the plane more accurately reflects the actual physical impression.

Embodiments of the invention may be used with specialized software, such as a Fabrication Software Application. An illustration of how one such software application might be used is shown in FIGS. 12A, 12B and 12C. The software application could be integrated in a fabrication device used in accordance with an embodiment of the invention, or it could be used on a separate device (e.g., computer, tablet, mobile device, etc.) and output data that can be directly or indirectly transmitted to a fabrication device. Alternative embodiments of the invention could support the use of a “pen and paper” prescription that is input into a fabrication system. FIGS. 12A, 12B and 12C are merely an illustration of one of many possible ways in which an embodiment of the invention could be used with software, and numerous alternative approaches are readily conceivable to one of ordinary skill in the art. Further, although the example herein relates to a foot orthotic, it is understood that similar software can be provided in accordance with embodiments of the invention with respect to other custom medical devices, in which case the features and options provided by the software could differ and relate particularly to the type of custom medical device being manufactured.

FIG. 12A illustrates graphical user interface (GUI) 1200 for using exemplary software in an embodiment of the invention. The software can be used to customize an orthotic for fabrication by a 3D Printer. GUI 1200 could be displayed on the digital monitor of a 3D Printer, computer, tablet, etc. Image 1201 reflects a digital representation of a patient's anatomy (in this instance, a foot) and can be selected 1202 for active user editing. In this embodiment, the margin of the shells 1238 are shown, and can be manipulated using the cursor 1239. The margin of the forefoot extension 1240 is also depicted, and can be manipulated or removed. Image 1201 can be displayed such that the surfaces shown will be an orthotics' dorsal aspect, i.e., the aspect which comes into contact with the plantar aspect of the foot. Image 1201 can also optionally display only portions of a foot, such as in instances where an orthotic is being created for only part of a foot. Different views and additional data can also be displayed.

GUI 1200 can display a basic orthotic shell generated for a patient's foot that can be modified according to any external constraints, e.g., shoe shape or mechanical profile, and can be modified automatically or by manual input. For example, GUI 1200 has an input for external constraints 1203. Other advanced features or clinical tools 1204 could be made available as well. For example, data pertaining to the patient's pressure maps or mechanical data about a shoe could be visually superimposed on Image 1201 so the customized orthotic takes that information into account (automatically or manually).

In the particular embodiment shown in FIG. 12A, arrows 1205 and 1206 can be displayed so a clinician can jump back and forth between different steps provided by GUI 1200 for customized an orthotic for fabrication. For example, clicking on back arrow 1205 may return a clinician to an anatomy acquisition step that resulted in generation of the digital representation shown in Image 1201. A patient history tab 1207 can be provided so a clinician can view or edit the patient's medical information or records. GUI 1200 reflects at least possible three elements in this step of designing a custom medical device: (1) setting the shell base properties, as provided in drop down menu 1218, (2) shell modifications, provided in drop down menu 1219 (see also FIGS. 12B and 12C), and (3) posting, in drop down menu 1220. As can be seen in drop down menu 1218, a clinician can modify the stiffness of the orthotic shell by adjusting a slider 1208—or by pressing minus sign 1209 or plus sign 1210 buttons—to adjust the Young's Modulus, which is expressed in terms of pounds per square inch (PSI) in editable readout 1211. Other measures of stiffness can additionally or alternatively be used, and for example GUI 1200 provides labels (e.g., pillow, cork, brick) to provide a clinician with guidance as to various settings. Marker 1212 for default shell stiffness (i.e., most commonly used) can be placed on stiffness scale 1213, as well. Separately, a clinician can selected the desired top coat pattern from a range of options, such as loose woven pattern 1214, uniform high density pattern 1215, or a midrange option such as pattern 1216 or pattern 1217. The clinician choice, which may be automated by decision algorithms, may demand on factors such as aesthetics, breathability, gripping ability, etc.

Having selected the orthotic shells' basic properties and a top coat(s) for the shells from drop down menu 1218, the clinician may desire to modify the shells. In FIG. 12B, GUI 1200 is shown with drop down menu 1219 selected so the clinician can modify the shell design using tools comparable to those available for traditional orthotic padding and cutouts. When shell modification drop down menu 1219 is selected, GUI 1200 in accordance with one embodiment of the present invention can maintain the same overall layout as in FIG. 12A, with much of the labeling and layout preserved for ease of use. With respect to the shell modification tools, an array of standard pads may be displayed, with some common examples being U-Shaped Pad 1221, Met Pad 1221, and 1st Met Cutout 1222 are shown. Additionally, custom shaped pads may be shown, such as with pad 1223. This allows the clinician to load a previously stored custom pad or cutout shape. Among other possible methods of pad input, design of such custom pads could be created such that the clinician can use a simple drawing applet wherein pixel size corresponds to printer resolution.

In FIG. 12C, GUI 1200 is shown with a orthotic displayed in digital representation 1202 which previously had its shell modified with U-Shaped Pad 1224 and is currently being modified with Met Pad 1225, which can also be displayed on the left-hand side of GUI 1200. By employing feature detection algorithms and heuristics about relative positioning, pad 1225 can be placed by default in a recommended position on image 1201, but the clinician may be able re-position pad 1225, such as by using rotation tool 1226, and scaling tool 1227. The height (extending past the shell) and depth (extending into the shell) of the pad can be adjusted. Large middle tick mark 1228 can represent the flush margin of the orthotic shell, with points to the left extending into the shell and points to the right above the shell. In a traditional orthotic manufacturing process, left points could be seen as a portion of the shell which is cut out to fit a pad, and right points could be seen as the height which the pad extends past flush with the margin of the shell. By adjusting the position of sliders 1229 and 1230, the relative positioning of the pad with the shell can be changed. Indicator 1231 indicates the thickness of the pad. Similarly, pad stiffness indicator 1232 reflects the pad stiffness, which can be adjusted using slider 1233 in conjunction with reference points of the pad's default stiffness 1234 and the current shell stiffness setting 1235. Some embodiments of the invention may only show the aggregate stiffness of the shell (i.e., complete orthotic) or combined orthotic-shoe structure at various regions, rather than pad-specific stiffness. The embodiment shown in the preceding figures is configured as such to closely reflect the current prescription thought process, which does not occur in terms of compression levels, per se, allowing the clinician to utilize this novel invention in a manner that maintains some semblance of pre-existing prescription logic. Additional features or options may be presented on GUI 1200, such as check box 1236 to save the configured settings, or “x” box 1237 to delete the current configuration and display the default settings. Yet other features, options or variations of the description herein may be presented on GUI 1200 used to achieve similar results, as well as for designing cutouts, which may be created with low density fill patterns or by creating actual holes in the shell.

After completing the modifications, the clinician may proceed to further steps provided by GUI 1200, which could include final orthotic visualization and finalization, and then submission for fabrication, optionally with progress monitoring and error handling. Various embodiments may utilize advanced 3D rendering, biomechanical, modeling and simulation, especially useful in pre-production fit analysis and posting prescription, among a wide variety of other uses. As discussed above, some embodiments of the invention may integrate fabrication and scanning tools connected to a single gantry system. In such embodiments, a GUI may include a tool that allows the clinician to pause a fabrication in progress in order to use the scan tools on the same or on a different work surface in a manner that does not interfere with the fabrication in progress.

Several other aspects of certain embodiments of the invention are now described. Certain embodiments of the invention may combine additive manufacturing techniques with other manufacturing techniques. For example, an embodiment could integrate or utilize a 3D Printer as well as other tools together in one or more devices. Such embodiments might combine additive and subtractive techniques, such as creating an orthotic by milling a shell and incorporating padding and top coating using 3D-printing processes. Further, embodiments of the invention can support the use of additive manufacturing techniques in conjunction with traditional manufacturing techniques, such as creating custom medical devices which are partly build with 3P Printers and partly use mass-produced products. For example, in the case of orthotic insoles, an additive manufacturing process might be used to build a custom orthotic that is integrated into the existing sole of the shoe. In one of several possible scenarios, a shoe manufacturer may use an embodiment of the invention as an intermediate step in shoe manufacturing in order to combine mass-produced shoe components with custom components for sale as a single product. As another example, a 3D Printer can be used to fabricate a custom medical device directly onto a (partially formed) mass-produced insole residing on the 3D Printer's work surface, in order to add appropriate features that conform to a particular prescription. This technique may be employed to save the time and expense of using only a 3D Printer to fabricate a custom medical device.

Embodiments of the invention support using a 3D Printer to create a wide array of geometries and allow for the creation of novel orthotic types, such as orthotics designed specifically for high heels (e.g., with biomechanical correction at the forefoot and little to no material in the rear foot), or other specialized orthotic designs. Embodiments of the invention can also support the ability to manufacture an entire shoe (or other device) with a custom portion (e.g., insole), integrated right into the product. Embodiments of the invention can thus be used to fabricate a complete shoe or another product which integrates a customized component (for medical or other purposes). A clinician could not only select desired properties for a corrective orthotic, but could also select the desired attributes of the overall product (e.g., shoe), such as regions of resistance to puncture—for example to address wear on the dorsal aspect of the shoe caused by the toe's dorsiflexion—as well as desired exterior design patterns, color, etc. Embodiments can also be implemented to take advantage of data about a patient's gait, anatomy, and wear pattern (on existing shoes) to new create 3D Printed shoes which can have improved “wear resistance” in appropriate areas, specialized mechanical properties to correct the patient's gait or at least mitigate its impact on the patient's health (e.g., prevent joint damage caused by the traditional combination of an irregular gait and a regular shoe). Embodiments can also be used to create orthotics with geometries which maintain a desired position (e.g., upward slanted forefoot) of the toes to prevent hammer toe. Other applications of the described embodiments should be readily apparent to one of ordinary skill in the art.

One particular feature which distinguishes many embodiments from existing processes for orthotic production is that these embodiments can be made available at a single location, eliminating the logistical challenges and expenses often encountered when manufacturing custom medical devices at an off-site location. Embodiments of the present invention can be a desktop device which does not discharge significant debris or noise and can fabricate medical devices in a clinician's office or a retail location. In addition to eliminating logistical issues, these embodiments allow for the prescription and fabrication process to be unified. For example, a clinician can examine a patient, develop a prescription to alleviate the patient's medical issues, digitally scan the patient's anatomy (with or without a mold) and input the prescription to be digitally translated into fabrication instructions, decreasing the risk of human error and increasing precision and accuracy of the fabrication process. The clinician may even be able to fabricate a desired custom medical device while the patient waits, so the patient can try it immediately and ensure it fits properly. The standard of care can also be improved with embodiments of this invention by providing medical intervention more quickly (and perhaps more inexpensively) with orthotics that are more easily tolerated by the patient, given that the clinician will be able to address both clinical and comfort concerns more precisely.

While embodiments may be designed to rely on input from a clinician regarding the specifications for a custom medical device, embodiments may also be configured as automated systems which rely on measurements and heuristics to analyze the patient data and fabricate an appropriate medical device. Embodiments of the invention may also be used to fabricate a diverse product line of custom medical devices, such as orthotics, that are intended to address the most common clinical conditions without being customized to a particular patient's anatomy. This might be useful to achieve mass production goals while creating an varied array of products, as it might be cost effective only with these embodiments but not with traditional manufacturing methods.

Techniques such as controlled pin matrices may be used to simulate how it might feel to wear a custom medical device fabricated by an embodiment, in order to allow for pre-fabrication comfort testing. An orthotic could also be created with inflatable sections, such that different Young's Modula could be simulated by changing pressure inputs. A series of printed voxels (so called “3D pixels”) could also be created and arranged (manually) to simulate an orthotic prior to printing an actual medical device for a patient. Likewise, orthotics with inflatable sections or sensors/actuators could also be created to accomplish the same, or for other uses inside shoes, such as biofeedback applications.

Embodiments with software for controlling the additive manufacturing device might be configured to pass instructions locally and directly to the additive manufacturing device or may do so wirelessly (e.g., through WiFi or the Internet). Embodiments may have a GUI displayed on a monitor integrated into the fabricator, or a directly or wirelessly connected via a computing device. Indeed, embodiments may include a 3D Printer controlled by software operating locally or via cloud computing, such as using a server to transmit instructions to the 3D printer. This feature could be used to allow customers to submit fabrication orders, or allow software developers to write fabrication software, without having full access to the underlying 3D Printer or the printer control software. Embodiments may also allow a clinician to save and share custom mechanical profiles, as well as store the relevant clinical, manufacturing, and CAD data for patients.

Several existing devices may be modified or configured as an embodiment of the invention. As noted above, embodiments of the invention can be implemented as a single, integrated device, or as several associated devices. Embodiments may be implemented with “in-office” machines or with an offsite machine (or set of machines) which can receive job requests or instructions from a local or remote computer. Embodiments may be implemented in a wide array of additive manufacturing devices or similar equipment, such as an additive manufacturing device with subtractive (milling) technology included in the machine. Embodiments may also support an integrated or interchangeable tool head which can use a deposition tip and a laser (or other) scanner, in order to support both print and scan functionality on the same machine.

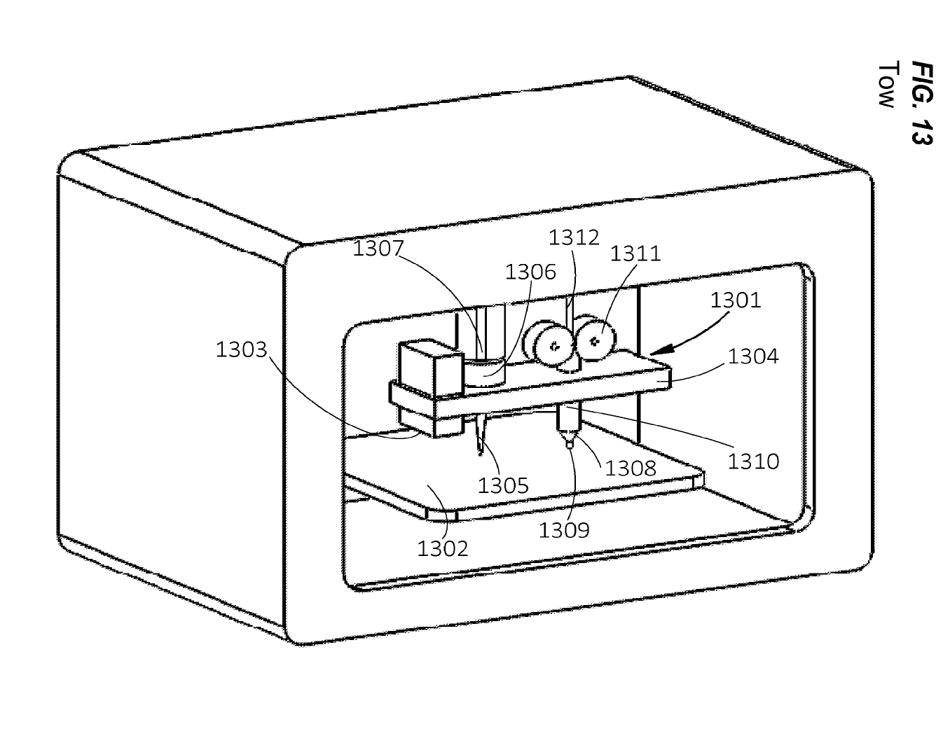

FIG. 13 illustrates many features of an embodiment that includes an integrated 3D printer device that may be used for in-office production of custom medical devices. Tool head 1301 may support different combinations or configurations and can be positioned above build surface 1302. In the example shown in FIG. 13, Tool head 1301 is configured with two fabrication tools and laser scanner 1303, adjoined in tool head chassis 1304. In this example, the fabrication tools use deposition-based techniques, although other additive (and subtractive, etc.) manufacturing technologies could be employed. Deposition tip 1305 can dispense fluid from material dispenser 1306, which is driven by piston 1307. (A pressure system can replace the mechanical piston.) This technique may be used, for example, to dispense air-curable materials such as silicone as well as ultraviolet (UV)-curable materials. Other materials like thermoplastic elastomers (TPEs) could also be dispensed this way (possibly requiring a heating element as well). Dispensing tip 1308 is shown extruding heated filament 1309 after it was passed through heated chamber 1310 via extrusion drive mechanism 1311 (e.g., pinch wheel, screw, gear, etc.), which passes cold filament 1312 through the system to be heated and deposited appropriately on build surface 1302. This technique could be used in one or more tools on such a tool head 1301 to dispense a thermoplastic, such as acrylonitrile butadiene styrene (ABS) or poly lactic acid (PLA), or a thermoplastic elastomer/resin (TPE/TPR). Other exemplary tool heads include those which may receive pelleted materials and use screw extrusion or other mechanisms to extrude the materials. Combining materials such as ABS and TPE can be performed by extruding compatible materials and controlling the temperature and flow rates appropriately for ideal material calibration, and to induce maximum bonding, which may require using high temperatures to allow materials to diffuse into one another. In addition, mechanical methods such as printing a textured surface or interlocking geometries could help ensure a multi-material object does not fall apart. The tool heads shown in FIG. 13 could be employed by an embodiment of the invention to create a multi-material custom medical device such as an orthotic.

It is possible for an embodiment to use several (at least two) different printing resolutions to increase the fabrication speed. For example, deposition tip 1308 may be used to quickly extrude the majority of an orthotic device (e.g., the shell material) at a course resolution (e.g., by using a wide lumen tip), while a deposition tip 1305 may be used with a finer resolution (e.g., by using a narrower lumen tip) to fabricate a top coat for the orthotic, such that the product has a finer exterior resolution. This can accelerate the process for fabricating custom medical devices while maintaining a high external feature resolution. Likewise, if deposition tip 1305 is used for a soft material, it can print finer internal resolutions at required points, while allowing the fabricator to operate at lower resolution in other instances.

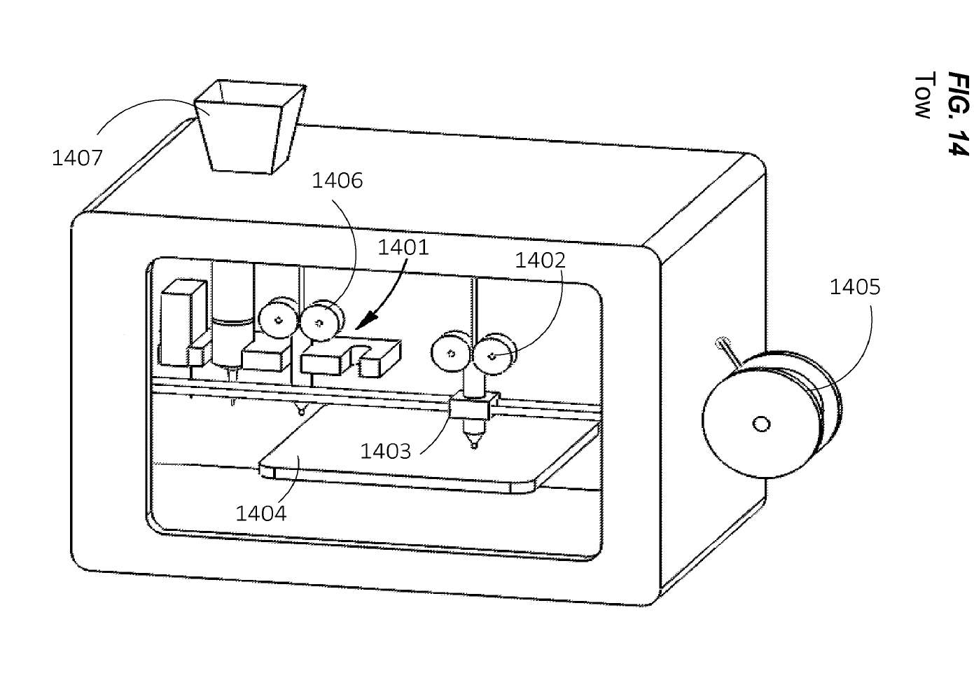

FIG. 14 illustrates an optional feature for an embodiment: a rack of tools 1401 having tools that can replace dispensing tool 1402, which is shown as attached to tool head 1403 above build surface 1404. Dispensing tool 1402 is a filament extruder receiving material from filament reel 1405, as is common in many filament extrusion 3D printing systems. A hopper 1407 can receive raw (possibly heterogeneous) material, such as pellets, powders, or liquids and create filament for another tool 1406 which may be used in place of the active tool 1402 shown.

Several other aspects of certain embodiments of the invention are now described. As shown in the preceding figures, the invention may be practiced using cartridges of materials. These cartridges may be refillable, disposable, single or multi use. Cartridges can be configured to prevent reuse by utilizing integrated pistons which can be driven forward, but not backwards (except by small increments as required for fluid dispensing procedures). This can be accomplished using cartridges with integrated pistons driven forward by breakable teeth, which encounter a breaking mechanism after being pushed forward by a motor, or by other means such as mechanically preventing significant backwards motion using angled, one-way gates. (The distance between teeth or gates allows minimal, necessary backwards motion.) Soft, deformable cartridges might be configured in stages which snap together irreversibly upon compression (dispensing). Likewise, the use of one-way valves at the dispensing tip may also be used to prevent refilling. Further, the invention may be practiced using pressurized cartridges which are valved such that the 3D Printer can be maintained at dispensing pressure upon the interchange of cartridges. Alternatively, cartridges may have integrated tip/valve mechanisms or such elements may be part of the pressure chamber in which such cartridges are inserted. Insertion of cartridges may be guided by specialized mating grooves or lock/key mechanism used to align the cartridge or to prevent use of cartridges created by unapproved vendors lacking such mechanisms.

In some embodiments of the invention, the Fabrication Software Application or other software can collect usage data and validate whether the materials used by the device (including cartridges, impression kits, and other accessories) are properly registered with the device vendor. This can be accomplished by optical scanning, manual serial code input, or through an integrated order tracking system which compares the materials purchased and used by a single machine (clinician) against a database of past purchases. In the context of orthotics, a database may track the number of impression kits and amount of materials purchased, matching that quantity to the quantity consumed by the fabrication device to assure that the clinician is using approved materials. The machine may be disabled remotely should consumed materials exceed purchased ones.

In certain embodiments, 3D Printers can be used in which multiple fluid materials may be dispensed using a single head with several fluid lines interchanged using a channel selection mechanism. In pressure-based dispensing devices used to practice the invention, pumping may be accomplished employing a variety of pumps, using printer path speed variation (to thin/thicken a deposition path) as a means to maintain uniform deposition throughout cyclical pressure changes. Such pumping systems, which may input material from external hoppers, may employ a variety of means to eliminate any unintentionally entrapped air, including dripping material strands from a height to thin them and remove air bubbles, or using rotating forces to expel bubbles. Alternatively, purging air bubble containing material, should it be present, in a pre-deposition chamber in the tool head can be done by measuring such a chamber of known material for unexpected differences in weight, spectrophotometer, ultrasound, or dielectric reading.

Embodiments of the invention which use multiple machines can be practiced using interchangeable work surfaces transferred using conveyor belt mechanisms, and the printing may be accomplished by the use of multiple print heads staggered at successive heights. The work surfaces may be connected by any number of means such as magnetic interlock and be capable of movement in many directions and angles. Such systems of manufacturing would enable one to create a manufacturing setup which would allow for a serial additive manufacturing process, wherein each 3D printer would perform part of the process of manufacturing a product. Alternatively, such a system could be used such that a complete manufacturing process for one finished item could occur on each individual printer. In such scenarios, each 3D printer represents a modular piece of the manufacturing equipment that can be replaced without interrupting the overall manufacturing process. For example, if one 3D printer breaks, it can simply be removed from the line and replaced. Alternatively, if the additive manufacturing process splits deposition tasks for creating a single product among several printers, the manufacturing process can simply adapt. So, if printer number two is broken and each printer is responsible for depositing one layer to manufacture a particular item, then printers one or three could simple double their task and deposit two layers instead of one, allowing the manufacturing process to continue despite a broken module. The same can be used as a mechanism of adjusting usage of printers intentionally to control costs, throughput time, or to scale a process so that each machine functions at some percentage, X %, of its capacity.

Embodiments of the invention could also be practiced using 3D Printers with other specialized features, such as a three axis robotic motion system which moves in two directions (e.g., x-y) under motorized power and a third (e.g., z) by mechanical means, such as might be the case if planar x-y motion of the tool to a particular build tray location actuates downward z-movement of the work surface. Other such specialized features include environmental (e.g., temperature, UV light, etc.) control of the build chamber or a separate curing chamber.

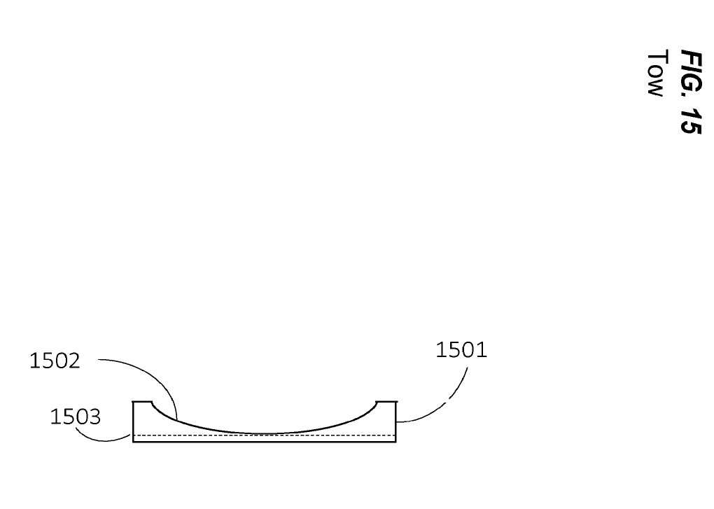

FIGS. 15-17 illustrate exemplary build trays (i.e., work surfaces) that may be used by embodiments of the invention, wherein the work surface used in an additive manufacturing process is not a flat surface, but rather can be a particular shape or texture. These surfaces can aid in the fabrication of complex objects by minimizing (or eliminating) the need to use dissolvable or separable support material to suspend fabrication material in space, as is often needed when fabricating an object.

FIG. 15 illustrates a non-flat build tray which allows printing of an object with a spheroid bottom of several layers without having to print any support material for those layers. As can be visualized by tray cross section 1501, raised surface 1502 can be used to produce curved objects without needing a support material to fill gaps between the lowest point on the tray indicated by dashed line 1503 and raised surface 1502. This design may be particularly beneficial in processes where customization takes place within internal geometry (rather than external geometry) of a shape, as use of this build surface could save material and simplify the printing process. The non-flat tray may or may not be designed to be reusable and may or may not be designed to be removable and/or part of the printed product.

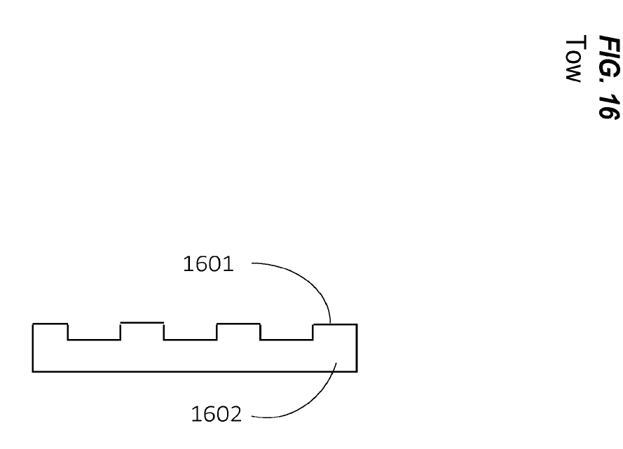

FIG. 16 illustrates a cross-section of a non-flat, textured build tray. Raised surface level 1601 circumvents the need for support material for tray 1602. This exemplary work surface could be used to create a textured bottom of a fabricated item. For example, an orthotic can be fabricated with this build tray to have a textured gripping surface on the plantar aspect of the orthotic that makes contact with the shoe.

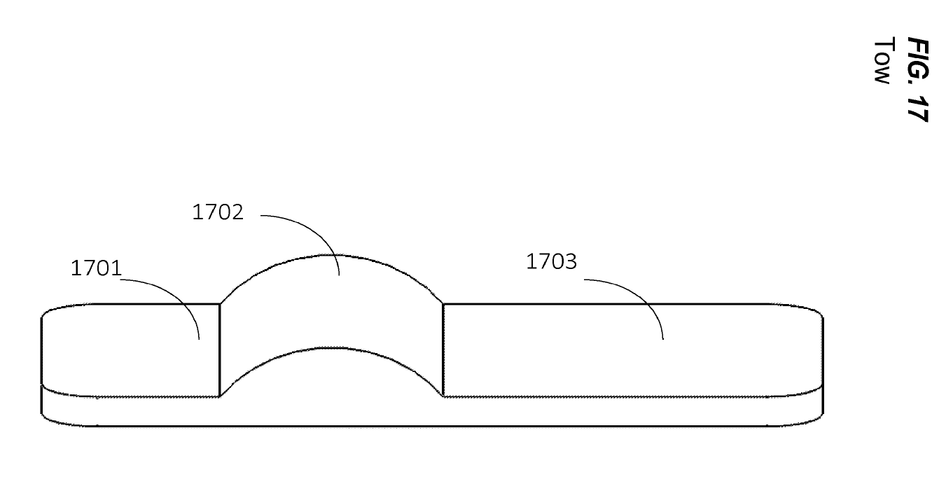

FIG. 17 illustrates a perspective view of a non-flat build tray that may be used, for example, to fabricate an orthotic with a non-flat bottom (e.g., a curved arch; see FIG. 3). Flat surface area 1701 could be used to print the heel, raised and curved surface 1702 could be used to print the arch, and flat surface 1703 could be used to print the forefoot portion of an orthotic. The work surfaces in FIG. 17 may also incorporate a textured pattern, such as the one in shown in FIG. 16.

Other embodiments of the invention may, instead of using premade surfaces, utilize dynamic or automated trays, such as a build tray wherein an array of actuated pins beneath a flexible covering can create a custom work surface by moving up and down, as needed.

Embodiments may use 3D Printers with switchable or removable build trays (i.e., work surfaces), or alternatively with build trays permanently affixed to the 3D Printer, or disposable/reusable work surface liners. Some configurations may even use stackable build trays (which may be disposable). For example, stackable build trays could be maneuvered by a spring-loaded cartridge or similar, which would allow for the trays to be removed and/or replaced by a clinician. A cartridge containing build trays (or build tray liners) could be used such that when a clinician removes a build tray with an orthotic printed onto it, the cartridge's spring-loaded system could replace the removed build tray with a new tray.

Another feature of embodiments of the invention is the use of multiple work surfaces (i.e., two or more), in distinction from traditional single work surface additive manufacturing or CNC devices. In this fashion, multiple tasks can be conducted on the same device. For example, an embodiment being used to fabricate a first set of orthotics on a work surface can pause fabrication (without removing the work-in-process), scan a patient's mold or physical anatomy (for a different orthotic) on a different work surface, and then resume fabrication of the first orthotics set. These embodiments of the invention can be implemented for multi-property medical device fabrication, as well as for a variety of other general 3D Printing and CNC applications.

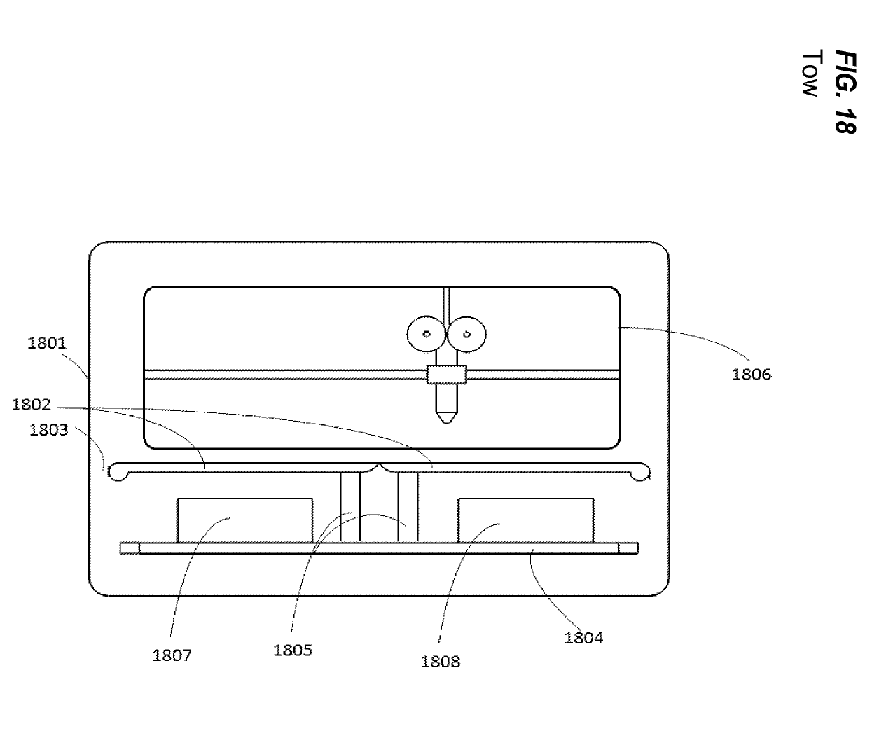

FIG. 18 illustrates an additive manufacturing device 1801 having a second work surface (i.e., build tray) 1802 affixed to side wall 1803. Second work surface 1802 (comprised in this illustration as two flaps) may optionally rest on first work surface 1804 by means of support posts 1805. Items fabricated on first work surface 1804 may thereby be left undisturbed beneath second work surface 1802 while second work surface 1802 is being used. This could enable a user to switch between multiple tasks on a single machine. For example, a user could pause a fabrication process on first work surface 1804 to engage second work surface 1802 to manufacture a smaller job or to engage in another function of the device (such as laser scanning, digital imaging or pipetting). In the embodiment shown, for example, objects 1807 and 1808 on first work surface 1804 might be orthotics in the middle of fabrication, which are protected from accidental human damage upon the engagement of second work surface 1802. This feature offers versatility and new capabilities to a 3D Printer device, as certain materials may not be moveable from a work surface during fabrication, and may be ruined if another function must be conducted. Second work surface 1802 may be positioned such that upon engagement of second work surface 1802 from its unused position along sidewall 1803 to its engaged position (as shown in the drawing), first work surface 1804 is no longer accessible via the device's opening 1806, to prevent accidental damage to an object on the surface of first work surface 1804; (the chassis in FIG. 18 is translucent for illustration purposes.) Similarly, support posts 1805 could also extend around some or all of the perimeter of second work surface 1802, as an alternative means of protecting an object on the surface of first build tray 1804. (For example, support posts 1805 may only extend at the front and back portions of the perimeter, rather than resting in the middle of the primary work surface and splitting it, as might be acceptable in the embodiment in which two orthotic insoles are being fabricated on first work surface 1804.) Alternative embodiments may actuate the descent and ascent of the two flaps of the second work surface 1802 upon the movement of first work surface 1804 to or from a bottommost position. This may be accomplished mechanically with or without separate actuation motors: For example, without additional motors, by the use of a weighted door and an appropriate hinge, actuated by the normal work surface motion.

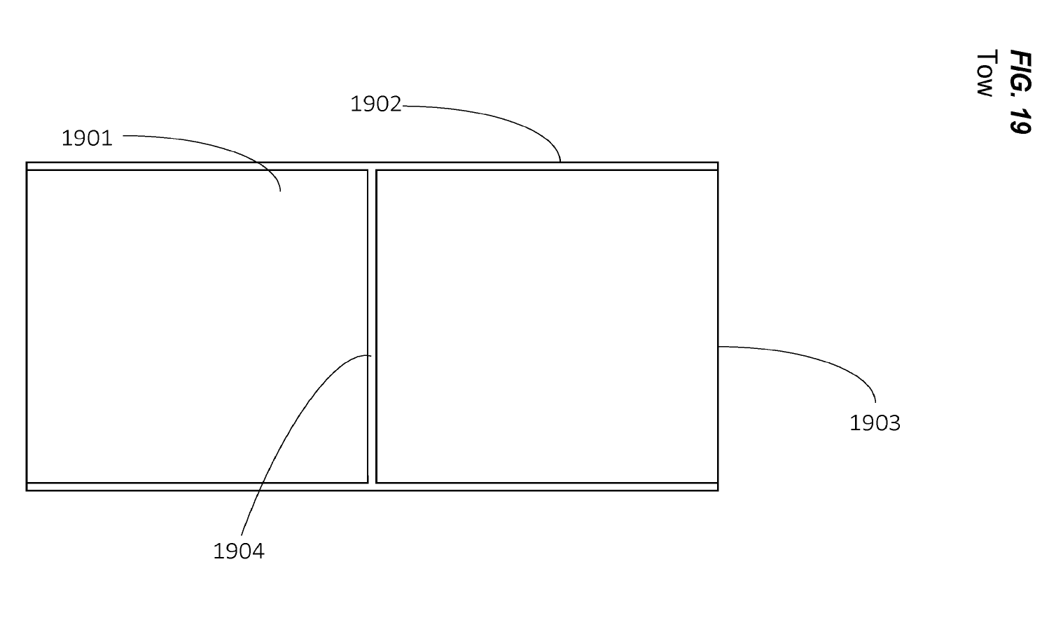

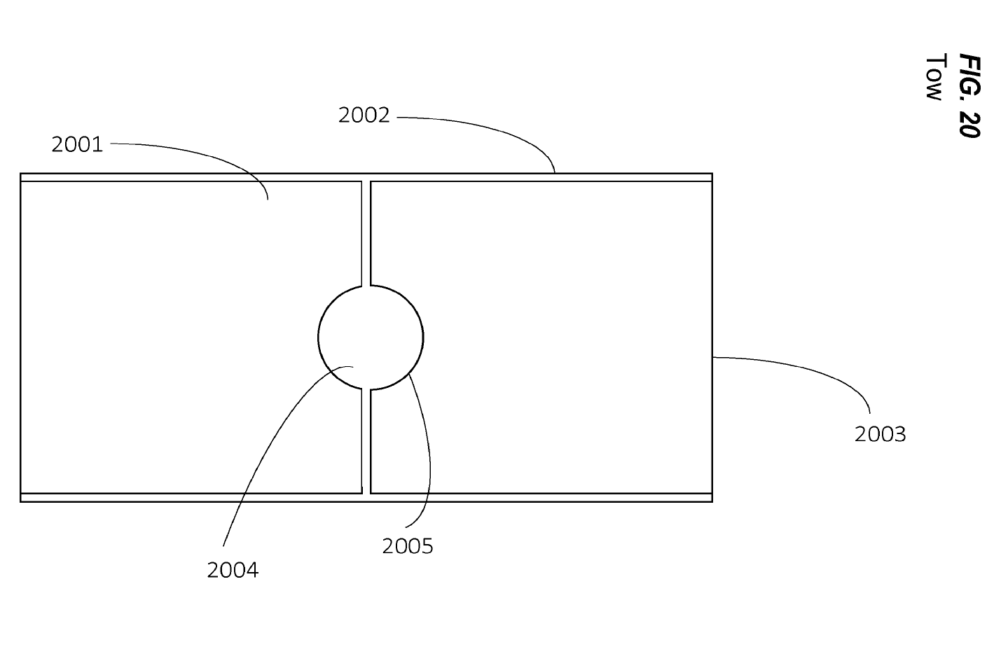

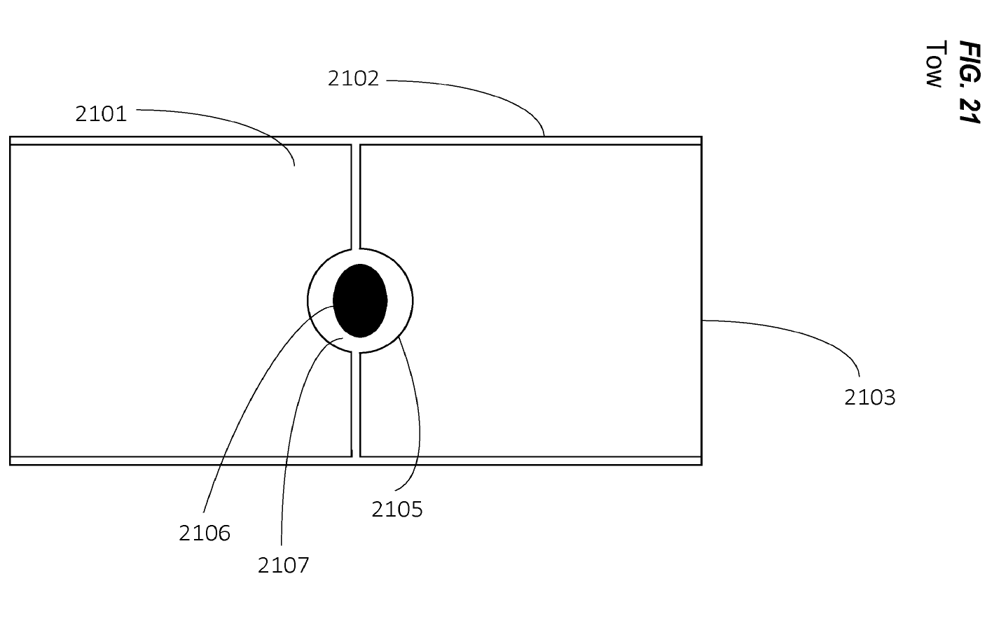

Various exemplary designs for a second work surface are provided with respect to FIGS. 19-21. Although these figures only depict the use of two work surfaces, other embodiments of the invention may utilize several work surfaces. FIG. 19 illustrates a top down view of a second work surface 1901, as well as back wall 1902 of the device and sidewall 1903. The flaps of work surface 1901 can be rotated about a mechanism (e.g., a hinge) on sidewall 1903. In this embodiment, work surface 1901 has two flaps which can be closed flush or with a small gap 1904. FIG. 20 illustrates a top down view of a second work surface 2001, as well as back wall 2002 of the device and sidewall 2003. The flaps of work surface 2001 can be rotated about a mechanism (e.g., a hinge) on sidewall 2003. In this embodiment, work surface 2001 has two flaps which have cut out 2005 which can allow the flaps to close without bumping into a tool head that can occupy gap 2004. Engagement of a second work tray may require the tool head is moved to an appropriate position, such that cut out 2005 will allow the flaps of work surface 2001 to move into the closed position shown in FIG. 20. FIG. 21 illustrates a top down view of a second work surface 2101, as well as back wall 2102 of the device and sidewall 2103. The flaps of work surface 2101 can be rotated about a mechanism (e.g., a hinge) on sidewall 2103. In this embodiment, work surface 2101 has two flaps which have cut out 2105 which can allow the flaps to close without bumping into tool head 2106 that occupies gap 2107.

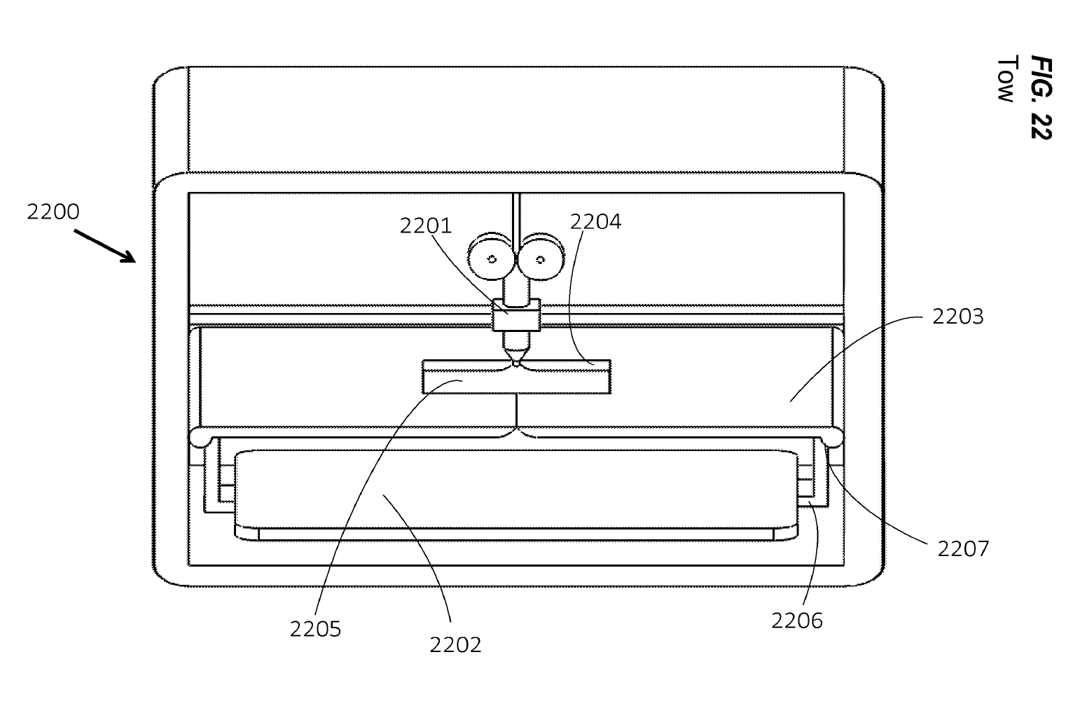

FIG. 22 illustrates multi-axis motion robot 2200 (e.g., embodied herein as a 3D Printer), along with tool head 2201, primary work surface 2202 and an engaged secondary work surface 2203, with cut out 2204 and gap 2205. In this embodiment of the present invention, when primary work surface 2202 moves to a position that depresses lever 2206, it actuates hinge 2207 and depresses secondary work surface 2203. Stated broadly, motion of primary work surface 2202 can be used to engage and disengage the secondary work surface 2203. However, many other mechanisms for alternating between a plurality of work surfaces are readily apparent. Such a technique could be beneficial in many instances. For example, in the manufacturing of orthotics and prosthetics (“O&P”), a clinician may desire to laser scan a patient's anatomy while the robot is manufacturing another patient's orthotic. The clinician (optionally using software) can direct tool head 2201 to pause operations and move primary work surface 2202 (containing a partially formed orthotic product) to depress the lever 2206 and engage secondary work surface 2203. The new patient's impression or physical anatomy could be placed to rest on secondary work surface 2203 to be scanned by, for example, a scanning component on tool head 2201. The orthotic fabrication process could then be resumed after removal of the impression and reinstatement of the primary work surface 2202 to the appropriate position for fabrication.

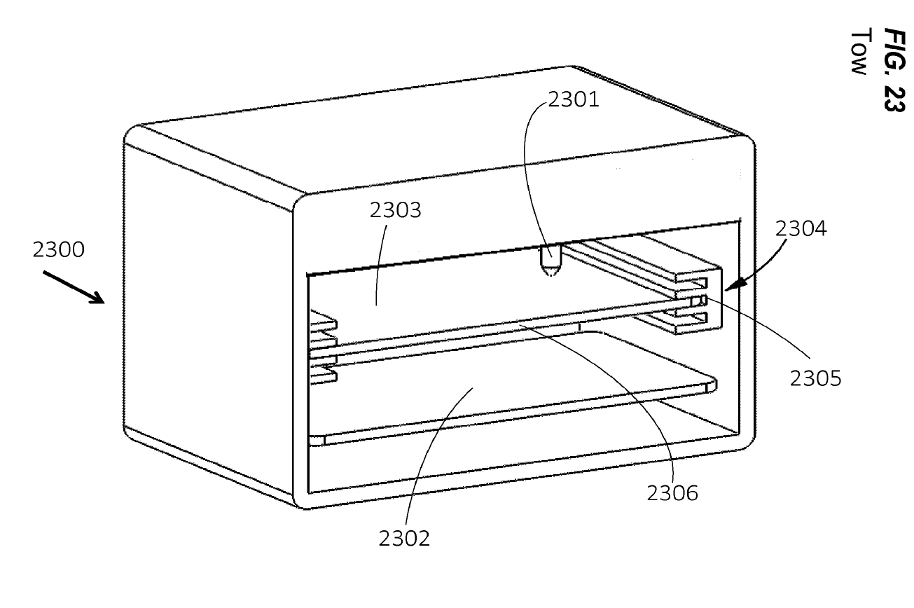

FIG. 23 illustrates multi-axis robot 2300 (e.g., a 3D Printer), as well as a tool head 2301, primary work surface 2302, secondary work surface 2306, and additional work surface rack 2304. In this embodiment of the present invention, additional work surfaces can slide into and out of a series of channels in the rack 2304 and rest on the support of a channel such as channel 2305. Work surfaces may also include a liquid bath (or powder bed) from which materials can be selectively cured or sintered, or a variety of surfaces with different geometric shapes and sizes (flat, spherical, etc.).

It will be appreciated by persons of ordinary skill in the art that the present invention is not limited to the exemplary embodiments illustrated and described herein, nor is it limited to the dimensions or specific physical implementations illustrated and described herein. The present invention may have other embodiments that are readily apparent and enabled as a result of the concepts and descriptions provided herein.

What is claimed is:

1. A three dimensional fabricator, comprising:
a control unit for receiving instructions from a fabrication command unit and operating at least one tool head; and
a plurality of work surfaces upon which the at least one tool head can fabricate a product.

2. A fabricator of claim 1, wherein the instructions specify the tool head fabricate a product customized for use by a particular person.

3. A fabricator of claim 1, wherein a first process using a first work surface can be interrupted, a second process can be initiated to use a second work surface, and then the first process using the first work surface can be resumed.

4. A fabricator of claim 1, wherein a first work surface is used for an additive manufacturing process and a second work surface is used for a laser scanning process.

5. A fabricator of claim 1, wherein a first process using a first work surface blocks access to material on a second work surface.

6. A three dimensional fabricator, comprising:
a control unit for receiving instructions from a fabrication command unit and operating at least one tool head; and
a work surface for fabrication of a product with the at least one tool head;
wherein the instructions specify a combination of at least two materials on the work surface to manufacture a product customized for use by a particular person.

7. A fabricator of claim 6, wherein the instructions are based in part on the person's anatomy or biomechanical properties.

8. A fabricator of claim 7, wherein the instructions are also based in part on the mechanical properties of a separate article or device which interfaces with the manufactured product.

9. A fabricator of claim 6, wherein the instructions specify a ratio or arrangement in three dimensional space of the combination of the at least two materials to yield different mechanical properties in different regions of the product.

10. A fabricator of claim 6, wherein the instructions specify a particular ratio or arrangement in three dimensional space of the combination of the at least two materials in one or more regions of the product.

11. A fabricator of claim 6, wherein the instructions specify a particular pattern to be manufactured in one or more regions of the product.

12. A fabricator of claim 6, wherein the instructions specify different printing processes for at least two regions of the product.

13. A fabricator of claim 6, wherein the instructions specify different internal geometries for at least two regions of the product.

14. A fabricator of claim 6, wherein the instructions specify at least one functional pattern on an external region of the product.

15. A fabricator of claim 6, wherein the instructions specify at least one functional geometry on an external region of the product.

16. A fabricator of claim 6, wherein the product is a medical device.

17. A fabricator of claim 6, wherein the product is an insole.

18. A fabricator of claim 6, wherein the product is footwear.

19. A method of using a three dimensional fabricator to manufacture a product, comprising the steps of:
sending instructions for a product with mechanical properties customized for a particular person from a fabrication command unit to a control unit;
operating at least one tool head with the control unit to fabricate a product on a work surface; and
fabricating the product with the customized mechanical properties on the work surface.

20. The method of claim 19, wherein the mechanical properties address a medical need of the particular person.

21. The method of claim 19, wherein the product is a medical device.

22. The method of claim 19, wherein the product is an insole.

23. The method of claim 19, wherein the product is footwear.

24. The method of claim 19, wherein fabricating the product further comprises the combining of at least two materials.

25. The method of claim 24, wherein the at least two materials are combined with a specific ratio to achieve one or more of the selected mechanical properties.

26. The method of claim 19, wherein fabricating the product further comprises the use of at least two additive manufacturing tools.

27. The method of claim 19, wherein fabricating the product further comprises the fabrication of at least one internal geometry or pattern.

28. The method of claim 19, wherein different regions of the product are fabricated with at least two different patterns.

29. The method of claim 19, wherein different regions of the product are fabricated with at least two different printing processes.

30. The method of claim 19, wherein fabricating the product further comprises the fabrication of at least one functional pattern on an external region of the product.

31. The method of claim 19, wherein fabricating the product further comprises the fabrication of at least one functional geometry on an external region of the product.

32. A three dimensional fabricator, comprising:
a control unit for receiving instructions from a fabrication command unit and operating at least one additive manufacturing tool head and at least one subtractive manufacturing tool head;
a work surface for fabrication of a product with the at least one additive manufacturing tool head and the at least one subtractive manufacturing tool head;
wherein the instructions specify the fabrication of material on the work surface to manufacture a product customized for use by a particular person.

33. A fabricator of claim 32, wherein the product is a medical device.

34. A fabricator of claim 33, wherein the product is an insole.

35. A three dimensional fabricator, comprising:
a control unit for receiving instructions from a fabrication command unit and operating at least one tool head;
a work surface upon which a product is fabricated by at least one tool head;
wherein the instructions specify the combination of at least two materials on the work surface to manufacture a medical device.

36. A fabricator of claim 35, wherein the medical device is an insole.

37. A method of using a three dimensional fabricator to manufacture a medical device, comprising the steps of:
sending instructions from a fabrication command unit to a control unit;
operating at least one tool head with the control unit to combine at least two materials; and
manufacturing a medical device with the at least one tool head on a work surface.

38. The method of claim 37, wherein the medical device is an insole.
